(19) United States
(12) Patent Application Publication
(10) Pub. No.: US 2026/0225884 A1
(43) Pub. Date: Aug. 6, 2026

(54) CATALYSTS FOR MICROWAVE REFORMING OF HYDROCARBONS

(71) Applicant: UNIVERSITY OF HOUSTON SYSTEM, Houston, TX (US)

(72) Inventors: Xiaonan SHAN, Sugar Land, TX (US); Jiefu CHEN, Cypress, TX (US)

(73) Assignee: UNIVERSITY OF HOUSTON SYSTEM, Houston, TX (US)

(21) Appl. No.: 19/153,059

(22) PCT Filed: Feb. 6, 2024
(86) PCT No.: PCT/US2024/014600

§ 371 Date: Aug. 1, 2025

Related U.S. Application Data
(60) Provisional application No. 63/443,924, filed on Feb. 7, 2023.

(51) Int. Cl. C01B 3/40; C01B 3/50

(52) U.S. Cl. CPC C01B 3/40; C01B 3/50; C01B 2203/0227; C01B 2203/04; C01B 2203/0855; C01B 2203/1005; C01B 2203/1082; C01B 2203/1241

(57) ABSTRACT

This invention relates to catalysts for microwave reforming of hydrocarbons, systems incorporing the catalysts for microwave reforming of hydrocarbons, and methods for using the catalysts for microwave reforming of hydrocarbons.

### CROSS-REFERENCE TO RELATED APPLICATIONS

This application claims the benefit of priority under 35 U.S.C. § 119 (e) to U.S. Provisional Patent Application No. 63/443,924 filed Feb. 7, 2023, the contents of which is incorporated herein by reference in its entirety.

### FIELD OF THE INVENTION

This invention relates to catalysts for microwave reforming of hydrocarbons, systems incorporing the catalysts for microwave reforming of hydrocarbons, and methods for using the catalysts for microwave reforming of hydrocarbons.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Currently, about 96% of global hydrogen production is obtained from hydrocarbon (e.g., by coal gasification, oil/naphtha reforming, and steam reforming of methane). Some of the methods have a dramatic environmental impact owing to the large amount of CO₂ emissions. Coal gasification has the lowest production costs, but its CO₂ footprint is the largest. Steam methane reforming (SMR) is widely regarded as the most economical method for hydrogen generation (accounts for 48% of global hydrogen production) because of its low cost and the vast availability of methane from natural gas reserves, but this method also has a relatively large carbon footprint. Hydrogen generation via water electrolysis only takes 4% of the total production. This method can achieve zero carbon emission only if renewable electricity is used for the energy source. On the other hand, the fluctuation of renewable energies and large amount of energy consumption in electrolyzer requires the use of grid electricity, which is not always green and will lead to a large carbon footprint. In some situations, the carbon emission of electrolysis can be even higher than SMR and other methods.

Methane pyrolysis is one of the most promising methane reforming methods to produce hydrogen because the process only generates hydrogen and solid carbon, and thus, the formation of CO₂ is prevented during the reaction. The CO₂ emissions from methane pyrolysis are significantly lower than other methane reforming techniques, and the carbon footprint could be zero if renewable energy is used for production. In addition, methane pyrolysis is a one-step process, while SMR needs an extra step (water-gas shift reaction) to generate additional hydrogen and convert the CO to CO₂. In practice, the thermal energy required to initiate and sustain methane pyrolysis has generally been supplied via conventional heating, which has a relatively low efficiency.

Therefore, there is an ongoing need for improvements in hydrocarbon reforming, including methane pyrolysis. The embodiments of the present invention address that need.

### SUMMARY OF THE INVENTION

The following embodiments and aspects thereof are described and illustrated in conjunction with systems, apparatus, articles of manufacture, compositions, and methods which are meant to be exemplary and illustrative, not limiting in scope.

In various embodiments, the present invention provides a catalyst for microwave reforming of hydrocarbons, comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy. In some embodiments, the three-dimensional structure comprises any geometry. In some embodiments, the three-dimensional structure is configured to maximize the temperature of the localized thermal hot spot. In some embodiments, the three-dimensional structure is configured to form a microwave plasma when subjected to microwave energy. In some embodiments, the catalyst body comprises a carbon-based material, a metal-based material, or combination thereof. In some embodiments, the carbon-based material comprises at least one of carbon foam, carbon fiber, active carbon, carbon black, charcoal, coal, biomass-derived carbon, or any combination thereof. In some embodiments, the metal-based material comprises at least one of aluminum, stainless steel, maraging steel, nickel alloy, titanium, aluminum alloy, cobalt alloy, or titanium alloy. In some embodiments, the catalyst material is a carbon-based catalyst material, a metal-based catalyst material, or a combination thereof. In some embodiments, the carbon-based catalyst material comprises at least one of carbon foam, carbon fiber, active carbon, carbon black, charcoal, coal, biomass-derived carbon, or any combination thereof. In some embodiments, the metal-based catalyst material comprises at least one transition metal.

In various embodiments, the present invention provides a system for microwave reforming of hydrocarbons, comprising: a reaction chamber, wherein the reaction chamber comprises at least one input port and at least one outlet port; a catalyst of the present invention described herein positioned in the reaction chamber; and a magnetron for generating microwave energy, wherein the magnetron is in communication with the reaction chamber. In some embodiments, the system further comprises a hydrogen separator, wherein the hydrogen separator is in communication with the at least one outlet port.

In various embodiments the present invention provides a method for microwave reforming of hydrocarbons, comprising: providing a system of the present invention described herein; contacting the catalyst with microwave energy to generate a microwave plasma in the reaction chamber; adding a hydrocarbon feedstock to the reaction chamber via the at least one input port; contacting the hydrocarbon feedstock with the microwave plasma in the reaction chamber, and reforming the hydrocarbon feedstock with the microwave plasma to produce hydrogen.

In various embodiments the present invention provides a method for microwave reforming of hydrocarbons, comprising: providing a catalyst of the present invention described herein; contacting the catalyst with microwave energy to generate a microwave plasma; contacting a hydrocarbon feedstock with the microwave plasma; and reforming the hydrocarbon feedstock with the microwave plasma to produce hydrogen.

In various embodiments, the present invention provides use of a catalyst of the present invention described herein for microwave reforming at least one hydrocarbon.

Exemplary embodiments are illustrated in referenced figures. It is intended that the embodiments and figures disclosed herein are to be considered illustrative rather than restrictive.

### BRIEF DESCRIPTION OF THE DRAWINGS

FIG. 1 depicts in accordance with various embodiments of the invention, a catalyst for microwave reforming of hydrocarbons showing the formation of a localized thermal hot spot within the three-dimensional catalyst material or on a surface of the three-dimensional catalyst material. The position and/or area of the localized thermal hot spot (e.g., localized heating) is indicated by the arrow. The catalyst shown in FIG. 1 was designed and studied using COMSOL Multiphysics® software. The catalyst shown in FIG. 1 was subjected to simulated microwave heating in the reactor shown in FIG. 12 for 15 seconds.

FIG. 2 depicts in accordance with various embodiments of the invention, a catalyst for microwave reforming of hydrocarbons showing the formation of a localized thermal hot spot within the three-dimensional catalyst material or on a surface of the three-dimensional catalyst material. The position and/or area of the localized thermal hot spot (e.g., localized heating) is indicated by the arrow. The catalyst shown in FIG. 2 was designed and studied using COMSOL Multiphysics® software. The catalyst shown in FIG. 2 was subjected to simulated microwave heating in the reactor shown in FIG. 12 for 15 seconds.

FIG. 3A-FIG. 3D depicts in accordance with various embodiments of the invention, electric field and temperature distribution on a three-dimensional carbon foam showing localized heating (e.g., localized thermal hot spot formation). FIG. 3A depicts in accordance with various embodiments of the invention, temperature distribution on a three-dimensional carbon foam after five seconds of microwave heating. In FIG. 3A the position and/or area of the localized thermal hot spot (e.g., localized heating) is indicated by the arrow. FIG. 3B depicts in accordance with various embodiments of the invention, the electric field distribution around the three-dimensional carbon foam. FIG. 3C-FIG. 3D depicts in accordance with various embodiments of the invention, electric field distribution on the three-dimensional carbon foam at different angles. FIG. 3A-FIG. 3D and the three-dimensional carbon foam were designed and studied using COMSOL Multiphysics® software.

FIG. 4A-FIG. 4E depicts in accordance with various embodiments of the invention, temperature distribution changes over time on three-dimensional carbon foam, where the heating time is 1 second (FIG. 4A), 2 seconds (FIG. 4B), 3 seconds (FIG. 4C), and 5 seconds (FIG. 4D), FIG. 4E depicts in accordance with various embodiments of the invention a temperature vs. time curve showing that the temperature quickly increases to 1000° C. in 5 seconds for the three-dimension carbon foam structure. FIG. 4A-FIG. 4D show that the temperature distribution on the three-dimensional carbon foam is not uniform. The temperature distribution is localized to a specific area/region within the three-dimensional catalyst material or on a specific surface of the three-dimensional catalyst material thereby forming a localized thermal hot spot within the three-dimensional catalyst material or on a surface of the three-dimensional catalyst material. In FIG. 4D the position and/or area of the localized thermal hot spot (e.g., localized heating) is indicated by the arrow. FIG. 4A-FIG. 4E and the three-dimensional carbon foam were designed and studied using COMSOL Multiphysics® software.

FIG. 5 depicts in accordance with various embodiments of the invention, an example of a three-dimensional catalyst support. Without being limited by theory, the structure/geometry of the three-dimensional catalyst support will (i) enable and enhance the formation of the localized microwave plasma; (ii) allow gases to flow through the catalyst support; and (iii) aid in the removal of carbon produced during hydrocarbon reforming and/or hydrocarbon pyrolysis. FIG. 5 and the three-dimensional catalyst support were designed and studied using COMSOL Multiphysics® software.

FIG. 6 depicts in accordance with various embodiments of the invention, a schematic of a reactor/system design (experimental scale) for microwave hydrocarbon reforming.

FIG. 7 depicts in accordance with various embodiments of the invention, a schematic of a reactor/system design (experimental scale) for microwave hydrocarbon reforming.

FIG. 8 depicts in accordance with various embodiments of the invention, non-limiting examples of microwave hydrocarbon reforming reactions.

FIG. 9 depicts a graphic illustration of microwave heating compared to conventional heating.

FIG. 10A-FIG. 10F depicts in accordance with various embodiments of the invention, temperature distribution changes over time on three-dimensional carbon foam, where the heating time is 1 second (FIG. 10A), 2 seconds (FIG. 10B), 3 seconds (FIG. 10C), and 5 seconds (FIG. 10D). FIG. 10E depicts in accordance with various embodiments of the invention a temperature vs. time curve showing that the temperature quickly increases to 1000° C. in 5 seconds for the three-dimensional carbon foam structure compared to Ni foam and SiO₂ foam. On the other hand, after 5 seconds of heating, the temperatures of the Ni foam, and SiO₂ foam is less than 10° C. FIG. 10F depicts in accordance with various embodiments of the invention, a catalyst for microwave reforming of hydrocarbons showing the formation of a localized thermal hot spot within the three-dimensional catalyst material or on a surface of the three-dimensional catalyst material. FIG. 10A, FIG. 10B, FIG. 10C, FIG. 10D, and FIG. 10F show that the temperature distribution on the three-dimensional carbon foam is not uniform. The temperature distribution is localized to a specific area/region within the three-dimensional catalyst material or on a specific surface of the three-dimensional catalyst material thereby forming a localized thermal hot spot within the three-dimensional catalyst material or on a surface of the three-dimensional catalyst material. In FIG. 10D the position and/or area of the localized thermal hot spot (e.g., localized heating) is indicated by the arrow. In FIG. 10F the position and/or area of the localized thermal hot spot (e.g., localized heating) is indicated by the arrow. FIG. 10A-FIG. 10F and the three-dimensional carbon foam, the Ni foam, and the SiO₂ foam were designed and studied using COMSOL Multiphysics® software.

FIG. 11 depicts in accordance with various embodiments of the invention, manipulation and control of the geometry and the compositions of the catalyst structure for highly efficient hydrogen production.

FIG. 12 depicts in accordance with various embodiments of the invention, a simulated microwave reactor design used for modeling microwave reforming reactions and microwave pyrolysis reactions. The simulated microwave reactor was designed, established, and studied using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 13 depicts in accordance with various embodiments of the invention, a plot showing the changes in heating effect in a single cylindrical rod oriented lengthwise along the X-plane (i.e., X-axis) in the reactor shown in FIG. 12. The cylindrical rod had a fixed 50 μm radius and the length of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 14 depicts in accordance with various embodiments of the invention, a plot showing the changes in heating effect in a single cylindrical rod oriented lengthwise along the X-plane (i.e., X-axis) in the reactor shown in FIG. 12. The cylindrical rod had a fixed 5000 μm length and the radius of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 KW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 15 depicts in accordance with various embodiments of the invention, a plot showing the changes in heating effect in a single cylindrical rod oriented lengthwise along the Z-plane (i.e., Z-axis) in the reactor shown in FIG. 12. The cylindrical rod had a fixed 50 μm radius and the length of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 16 depicts in accordance with various embodiments of the invention, a plot showing the changes in heating effect in a single cylindrical rod oriented lengthwise along the Z-plane (i.e., Z-axis) in the reactor shown in FIG. 12. The cylindrical rod had a fixed 1000 μm length and the radius of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 17 depicts in accordance with various embodiments of the invention, a plot showing the changes in heating effect in a single cylindrical rod oriented lengthwise along the X-plane (i.e., X-axis) in the reactor shown in FIG. 12. The plot in FIG. 17 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 18 depicts in accordance with various embodiments of the invention, a plot showing the changes in heating effect in a single cylindrical rod oriented lengthwise along the Z-plane (i.e., Z-axis) in the reactor shown in FIG. 12. The plot in FIG. 18 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 19 depicts in accordance with various embodiments of the invention, the simulated heating effects of two isolated cylindrical rods. In the computer simulation the first cylindrical rod is oriented lengthwise along the Z-plane (i.e., Z-axis) in the reactor shown in FIG. 12, and the second cylindrical rod is oriented lengthwise along the X-plane (i.e., X-axis) in the reactor shown in FIG. 12. The cylindrical rods were subjected to simulated microwave heating in the reactor shown in FIG. 12 for 5 seconds using COMSOL Multiphysics® software. In FIG. 19 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 20 depicts in accordance with various embodiments of the invention, the simulated heating effects of two cylindrical rods joined together at a corner junction across the Z-plane and X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 20 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 21 depicts in accordance with various embodiments of the invention, the simulated heating effects of two cylindrical rods joined together at a center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 21 the positions and/or areas of the localized thermal hot spots (e.g., localized heating) are indicated by the arrows. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 22 depicts in accordance with various embodiments of the invention, the simulated beating effects of two cylindrical rods joined together at an angled center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented at an angle (45° C.) lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 22 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 23 depicts in accordance with various embodiments of the invention, the methane pyrolysis gas chromatography results from a collection of actual methane pyrolysis experiments that were conducted using a carbon fiber catalyst in a microwave oven. The microwave oven was operated at 2.45 GHZ and 1 kW. In FIG. 23 the term “standard carbon” means 0.3 grams of carbon fiber. In FIG. 23 the term “less carbon” means 0.1 grams of carbon fiber. In FIG. 23 the term “full carbon” means 0.5 grams of carbon fiber.

FIG. 24 depicts in accordance with various embodiments of the invention, the methane pyrolysis gas chromatography results from a collection of actual methane pyrolysis experiments that were conducted using a carbon fiber catalyst in a microwave oven. The experimental results shown in FIG. 24 were obtained using a “split carbon” setup. The microwave oven was operated at 2.45 GHZ and 1 kW.

FIG. 25 depicts in accordance with various embodiments of the invention, the methane pyrolysis gas chromatography results from a collection of actual methane pyrolysis experiments that were conducted using a carbon fiber catalyst in a microwave oven. The experimental results shown in FIG. 25 were obtained using a “split carbon” setup. The microwave oven was operated at 2.45 GHZ and 1 kW.

FIG. 26 depicts in accordance with various embodiments of the invention, a diagram that explains what is meant by “split carbon” setup, where two separate bundles of carbon fiber were packed in a quartz tube with a space being present between the two bundles of carbon fiber so that the carbon fiber bundles were not in contact with one another. As discussed above, a “split carbon” setup was utilized to perform the experiments discussed in FIG. 24 and FIG. 25 herein. In FIG. 26, the diagram of the “split carbon” setup shows two bundles of carbon fiber separated by plasma generated in an argon atmosphere (i.e., an argon plasma).

FIG. 27A-FIG. 27H depicts in accordance with various embodiments of the invention, time-lapse photographs of plasma generation from a single bundle of carbon fiber in a quartz tube filled with argon when subjected to microwave energy in a microwave oven. The carbon fiber used in the experiments shown in FIG. 27A-FIG. 27H possessed a long aspect ratio (i.e., a large length to radius ratio). The microwave oven was operated at 2.45 GHZ and 1 kW. FIG. 27A shows the carbon fiber bundle in the quartz tube filled with argon before being subjected to microwave energy. FIG. 27B shows the initial plasma spikes generated from a first end of the carbon fiber bundle in the presence of argon when subjected to microwave energy. FIG. 27C shows an increase in the size and position of the initial plasma spikes generated from the first end of the carbon fiber bundle in the presence of argon when subjected to microwave energy. FIG. 27D shows a further increase in the size and position of the plasma spikes generated from the first end of the carbon fiber bundle in the presence of argon when subjected to microwave energy. FIG. 27E shows a further increase in the size and position of the plasma spikes generated from the first end of the carbon fiber bundle in the presence of argon when subjected to microwave energy, and also shows plasma spikes generated from a second end of the carbon fiber bundle in the presence of argon when subjected to microwave energy. FIG. 27F shows a further increase in the size and position of the plasma spikes generated from the first end and the second end of the carbon fiber bundle in the presence of argon when subjected to microwave energy. FIG. 27G shows plasma formation at the first end and second end of the carbon fiber bundle in the presence of argon when subjected to microwave energy. FIG. 27H shows FIG. 27G shows plasma at the first end and second end of the carbon fiber bundle in the presence of argon when subjected to microwave energy.

FIG. 28A-FIG. 28C depicts in accordance with various embodiments of the invention, time-lapse photographs of plasma generation from a single bundle of carbon fiber in a quartz tube filled with methane when subjected to microwave energy in a microwave oven. The microwave oven was operated at 2.45 GHZ and 1 KW. FIG. 28A shows the carbon fiber bundle in the quartz tube filled with methane before being subjected to microwave energy. FIG. 28B shows the initial plasma hot spots generated within the carbon fiber bundle or from a surface of the carbon fiber bundle in the presence of methane when subjected to microwave energy. FIG. 28C shows an increase in the quantity, size, and position of plasma hot spots (thermal hot spots) generated within the carbon fiber bundle or from the surface of the carbon fiber bundle in the presence of methane when subjected to microwave energy. FIG. 28C also shows plasma formation from within the carbon fiber bundle or from a surface of the carbon fiber bundle in the presence of methane when subjected to microwave energy.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. Unless otherwise defined, all technical and scientific terms used herein have the same meaning as commonly understood by one of ordinary skill in the art to which this invention belongs. It should be understood that this invention is not limited to the particular methodology, protocols, and reagents, etc., described herein and as such can vary. The definitions and terminology used herein are provided to aid in describing particular embodiments, and are not intended to limit the claimed invention, because the scope of the invention is limited only by the claims.

As used herein the term “comprising” or “comprises” is used in reference to compositions, methods, systems, articles of manufacture, apparatus, and respective component(s) thereof, that are useful to an embodiment, yet open to the inclusion of unspecified elements, whether useful or not. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Although the open-ended term “comprising,” as a synonym of terms such as including, containing, or having, is used herein to describe and claim the invention, the present invention, or embodiments thereof, may alternatively be described using alternative terms such as “consisting of” or “consisting essentially of.”

Unless stated otherwise, the terms “a” and “an” and “the” and similar references used in the context of describing a particular embodiment of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. The abbreviation, “e.g.” is derived from the Latin exempli gratia, and is used herein to indicate a non-limiting example. Thus, the abbreviation “e.g.” is synonymous with the term “for example.” No language in the specification should be construed as indicating any non-claimed element essential to the practice of the application.

“Optional” or “optionally” means that the subsequently described circumstance may or may not occur, so that the description includes instances where the circumstance occurs and instances where it does not.

In some embodiments, the numbers expressing quantities of reagents, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, the term “coke” refers to carbonaceous deposits that form on the surface of catalysts or surface of the reactor used in the hydrocarbon reforming.

As used herein, the term “microplasma” means a plasma of small dimensions, ranging from tens to thousands of micrometers. In some embodiments, microplasmas can be generated at a variety of temperatures and pressures, existing as either thermal plasma or non-thermal plasma.

As used herein, the term “microwave plasma” means a plasma generated using microwave power. In some embodiments, the microwave power used to generate the microwave plasma is at a frequency of 2.45 GHz or any other microwave frequency. In some embodiments, the microwave power used to generate the microwave plasma is at a frequency of about 300 MHz to 30 GHZ.

As used herein, the term “magnetron” means a device that generates microwaves.

As used herein, the term “plasma” means a mixture composed of neutral particles, ions, and electrons. In some embodiments, plasmas can be generated at a variety of temperatures and pressures, existing as either thermal plasma or non-thermal plasma.

As used herein, the term “thermal hot spot” refers to a point, area, and/or region of an object, in an object, or on an object that is characterized by a measurable or noticeable higher temperature compared to other points, areas, and/or regions of the object, in the object, or on the object. Non-limiting examples of an object include a catalyst, a catalyst body, a catalyst material, a three-dimensional support, a surface of a catalyst, a surface of a catalyst body, a surface of a catalyst material, or a surface of a three-dimensional support.

As used herein, the term “localized thermal hot spot” refers to a thermal hot spot that is located at a particular point, area, region, and/or part of an object. Non-limiting examples of an object include a catalyst, a catalyst body, a catalyst material, a three-dimensional support, a surface of a catalyst, a surface of a catalyst body, a surface of a catalyst material, or a surface of a three-dimensional support.

### Catalyst Design Testing

As demonstrated in our work described herein, utilization of high absorption materials, such as carbon fiber, shows an ability to maximize microwave energy efficiently through use of complex three-dimensional (3d) structures. In previous studies, it has been reported that filling a gap or space in a container with compact material provided a high conversion rate based on the area of the container. However, these studies also reported a significant amount of coke buildup on the surface, which lowered the efficiency over time.

Therefore, one objective of the present invention is to improve the conversion rate per unit of surface area on the catalyst, while reducing and/or eliminating coke formation without wasting space. Without being bound by theory, we propose to achieve this objective by maintaining the plasma within the catalyst structure in order to keep the conversion rate high, without wasting space.

Historically, one of the biggest issues with pyrolysis is the degradation of the metallic catalyst that are commonly used due to carbon deposition as an unwanted by-product. The following models show the different effects of heating based on particular structural designs of the catalyst and positioning of the catalyst in the reactor.

Without being bound by theory, our approach to identify these ideal situations was to breakdown the individual components of the catalyst and/or catalyst system, and to analyze the heating of the individual components of the catalyst and/or catalyst system.

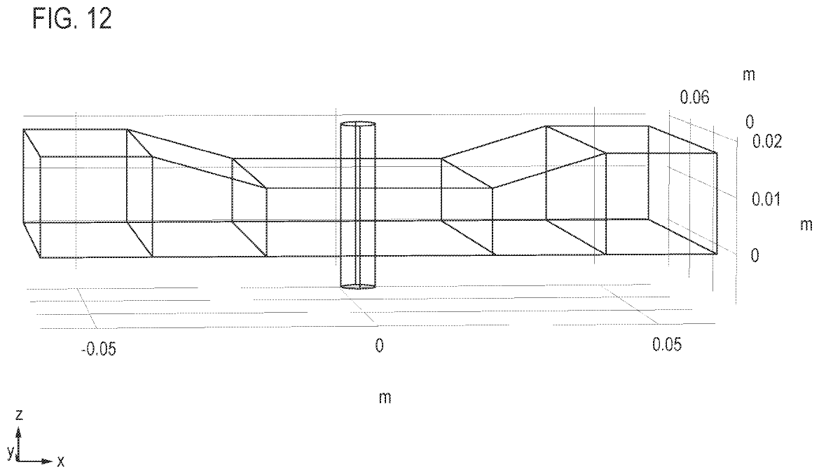

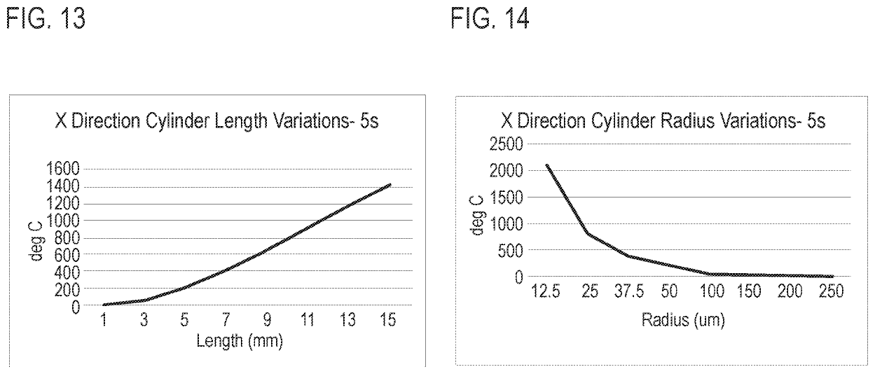

FIG. 13 shows the changes in heating effect in a single cylindrical rod oriented lengthwise along the X-plane (i.e., X-axis) in the reactor shown in FIG. 12. The cylindrical rod had a fixed 50 μm radius and the length of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 14 shows the changes in heating effect in a single cylindrical rod oriented lengthwise along the X-plane (i.e., X-axis) in the reactor shown in FIG. 12. The cylindrical rod had a fixed 5000 μm length and the radius of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 KW. The simulated electric field's oscillation direction is oriented along the Z-plane (i.e., Z-axis) throughout the entire reactor system, and the electromagnetic wave's propagation direction is oriented along the X-plane (i.e., X-axis).

Looking the FIG. 13 and FIG. 14 we observed that minor changes in length and/or radius of the modeled cylindrical rod provided a significant impact on the measured temperature. These results are significant, particularly in view of the fact that the active area of the modeled cylindrical rod is only 30 mm across. Furthermore, another noteworthy point that can be seen in FIG. 13 compared to FIG. 14 is that an increase in the length of the cylindrical rod provided a generally linear increase in temperature, while an increase in the radius of the cylindrical rod provided a generally exponential decrease in temperature. In FIG. 14 it is noteworthy in that micrometer increases to the radius of the modeled cylindrical rod resulted is a significant decrease in temperature.

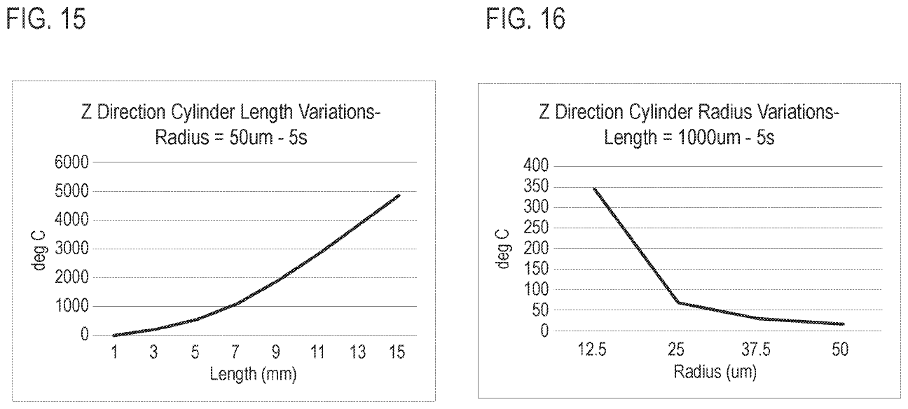

FIG. 15 shows the changes in heating effect in a single cylindrical rod oriented lengthwise along the Z-plane (i.e., Z-axis) in the reactor shown in FIG. 12. The cylindrical rod had a fixed 50 μm radius and the length of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 16 the changes in heating effect in a single cylindrical rod oriented lengthwise along the Z-plane (i.e., Z-axis) in the reactor shown in FIG. 12. The cylindrical rod had a fixed 1000 μm length and the radius of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 15 and FIG. 16 showed similar trends to those observed in FIG. 13 and FIG. 14, respectively. However, notably we observed that when the cylindrical rod is oriented lengthwise along the Z-plane (i.e., Z-axis) in the reactor the increase in temperature as shown in FIG. 15 was generally exponential when the length of the cylindrical rod was increased at a constant rate along the Z-plane (i.e., Z-axis) of the reactor. This is distinguishable from FIG. 13 where the rod is oriented along the X-plane (i.e., X-axis) in the reactor and the increase in temperature is generally linear when the length of the cylindrical rod was increased at a constant rate along the X-plane (i.e., X-axis) of the reactor.

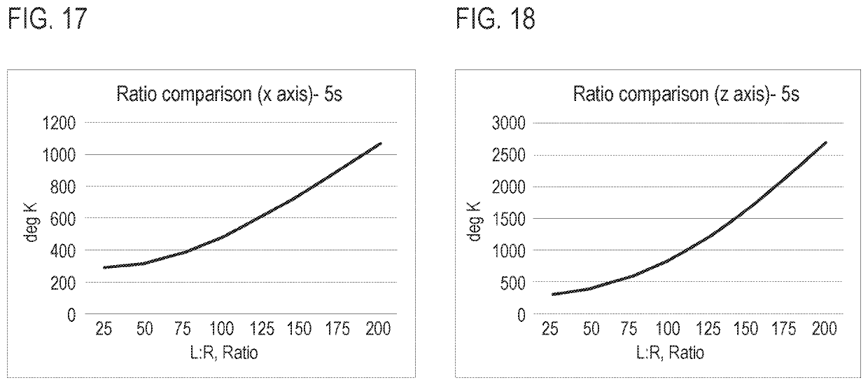

Following the individualized length and radius comparisons exemplified in FIG. 13-FIG. 16, we developed a hypothesis that the observed temperature effects were possibly a combination of both length and radius instead of merely length or radius alone. FIG. 17 shows the changes in heating effect in a single cylindrical rod oriented lengthwise along the X-plane (i.e., X-axis) in the reactor shown in FIG. 12. The plot in FIG. 17 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

FIG. 18 shows the changes in heating effect in a single cylindrical rod oriented lengthwise along the Z-plane (i.e., Z-axis) in the reactor shown in FIG. 12. The plot in FIG. 18 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

The exponential shape of the plots in FIG. 17 and FIG. 18 confirms that the differences we observed in the shape of the plots when the cylindrical rod was oriented along the X-plane (i.e., X-axis) in the reactor compared to the Z-plane (i.e., Z-plane) in the reactor were a result of axis or plane orientation instead of the individual length and radius variations that were tested.

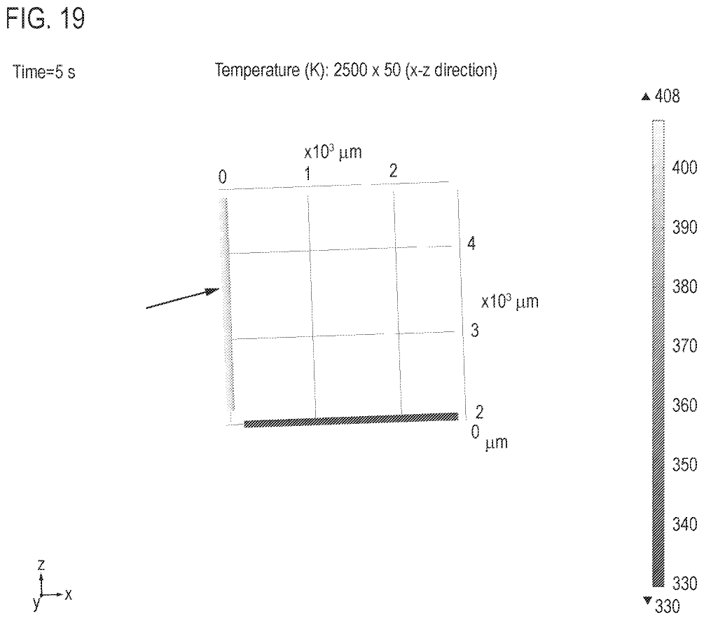

FIG. 19 shows simulated heating effects of two isolated cylindrical rods. In the computer simulation the first cylindrical rod is oriented lengthwise along the Z-plane (i.e., Z-axis) in the reactor shown in FIG. 12, and the second cylindrical rod is oriented lengthwise along the X-plane (i.e., X-axis) in the reactor shown in FIG. 12. The cylindrical rods were subjected to simulated microwave heating in the reactor shown in FIG. 12 for 5 seconds using COMSOL Multiphysics® software. In FIG. 19 the position and/or area of the localized thermal hot spot (e.g., localized heating) is indicated by the arrow. The simulated microwave reactor was run with constants of 2.45 GHZ and 1.2 KW. The simulated electric field's oscillation direction is oriented along the Z-plane (i.e., Z-axis) throughout the entire reactor system, and the electromagnetic wave's propagation direction is oriented along the X-plane (i.e., X-axis).

As can be seen in FIG. 19, the first cylindrical rod oriented along the Z-plane (i.e. Z-axis) in the reactor is affected at a significantly greater rate than the second cylindrical rod oriented along the X-plane (i.e., X-axis) in the reactor. The results in FIG. 19 are consistent with the results shown in FIG. 15 (cylindrical rod oriented along the Z-plane in the reactor) and FIG. 13 (cylindrical rod oriented along the X-plane in the reactor). In addition, in FIG. 19 it is noteworthy that there is little to no variation in heating across the length of the cylindrical rods.

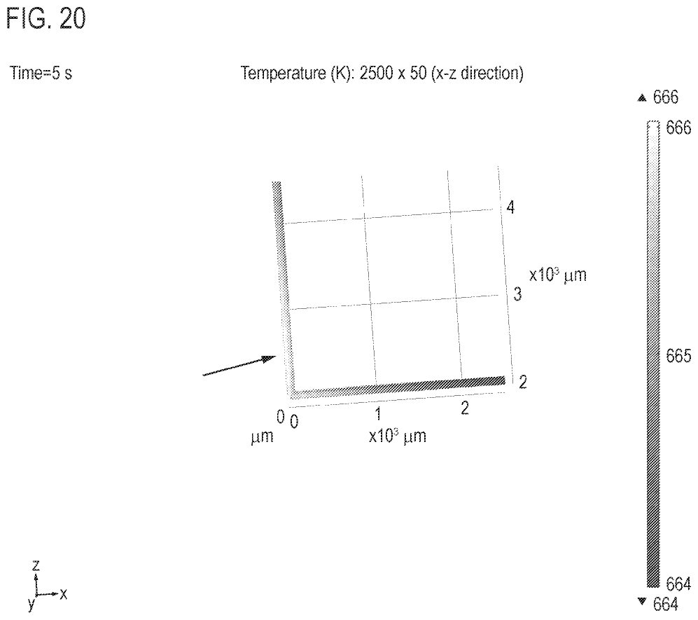

FIG. 20 shows simulated heating effects of two cylindrical rods joined together at a corner junction across the Z-plane and X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 20 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

In contrast to FIG. 19, in FIG. 20 the two cylindrical rods are combined together across the X-plane and Z-plane and are representative of a greater ratio rod even though they are combined across more than one plane or axis. In FIG. 20 the positions of largest temperature increase observed in the combined cylindrical rod are greater near the junction of the two cylindrical rods.

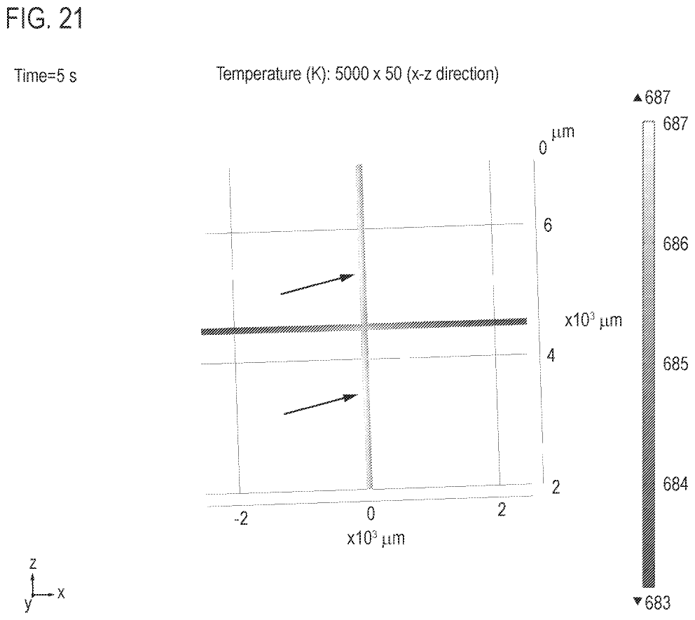

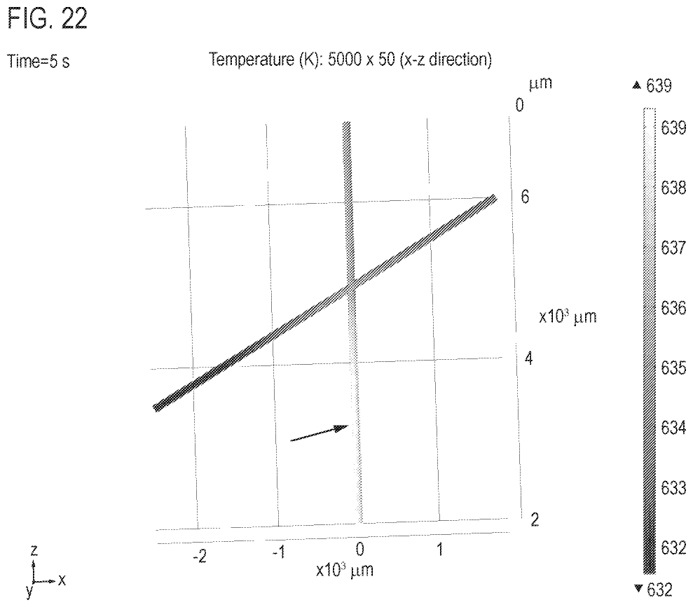

FIG. 21 and FIG. 22 expand on the concept of combining two cylindrical rods and show a very important piece of information pertaining to the junction effect. In FIG. 20 it was observed that the junction served as the position of the largest temperature increase in 90-degree simulations. In FIG. 21 and FIG. 22 we saw a difference in the location of the temperature increase when the junction was expanded out (FIG. 21) or when the junction was angled (FIG. 22).

FIG. 21 shows simulated heating effects of two cylindrical rods joined together at a center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 21 the positions and/or areas of the localized thermal hot spots (e.g., localized heating) are indicated by the arrows. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis). FIG. 21 shows that the thermal hot spots are now positioned symmetrically adjacent to the junction along the Z-plane.

FIG. 22 shows the simulated heating effects of two cylindrical rods joined together at an angled center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented at an angle lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 22 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis). In contrast to FIG. 21, FIG. 22 shows that the thermal hot spot is non-symmetrically shifted away from the junction along the Z-plane.

### Gas Conversion Experiments

Another objective of the present invention is the application of plasma (e.g., microwave plasma) for methane reformation and/or methane pyrolysis. Another objective of the present invention is to contact methane with a plasma (e.g., a microwave plasma) to directly convert methane to hydrogen while minimizing coke formation. Without being bound by theory, we observed that the amount of plasma generated in pure methane was less than the amount of plasma generated in argon. Therefore, based on these observations we performed experiments in pure methane, pure argon, and mixtures of methane and argon.

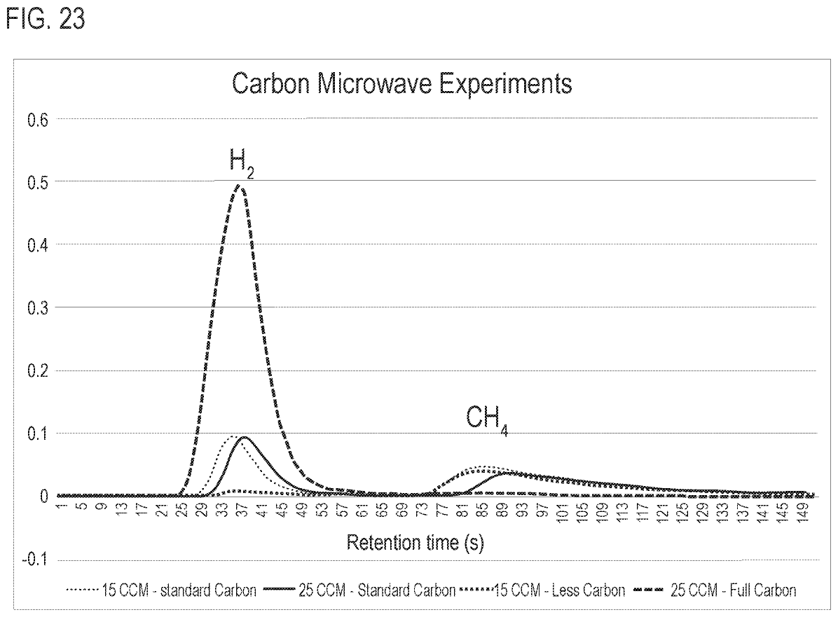

FIG. 23 shows the methane pyrolysis gas chromatography results from a collection of actual methane pyrolysis experiments that were conducted using a carbon fiber catalyst in a microwave oven. The microwave oven was operated at 2.45 GHZ and 1 kW. In the experiments shown in FIG. 23, a quartz tube was packed with carbon fiber at different packing densities.

The term “packing density” as used herein refers to the ratio of the volume of the packing material in a space to the volume of the space itself.

The experiments shown in FIG. 23 were performed to establish baselines for flow rate and to also determine certain parameters for the catalyst, such as positioning of the catalyst in the quartz tube and the packing density of the catalyst within the quartz tube. As shown in FIG. 23, the highest conversion rate was observed when the flow rate of methane was 25 cubic centimeters per minute (CCM) over full carbon. However, when full carbon was utilized coke buildup was observed on the walls of the quartz tubing, which overtime may reduce the conversion efficiency. In FIG. 23 the term “standard carbon” means 0.3 grams of carbon fiber. In FIG. 23 the term “less carbon” means 0.1 grams of carbon fiber. In FIG. 23 the term “full carbon” means 0.5 grams of carbon fiber.

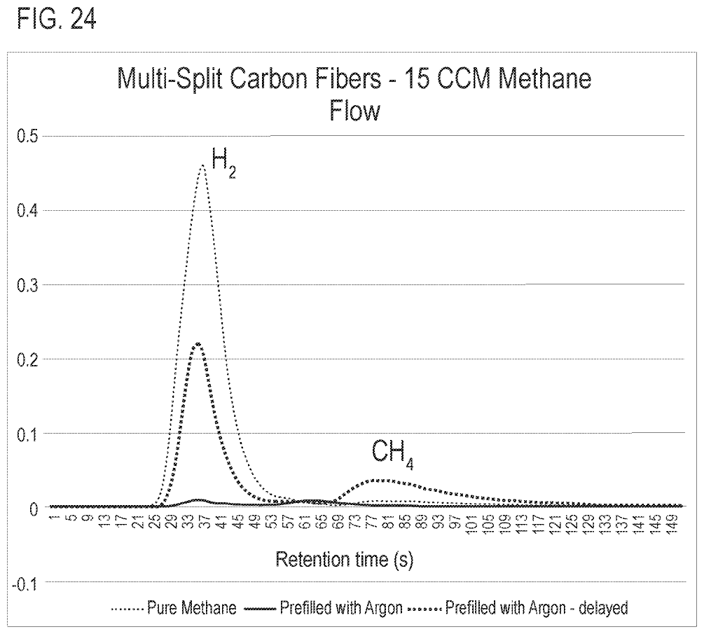

FIG. 24 shows the methane pyrolysis gas chromatography results from a collection of actual methane pyrolysis experiments that were conducted using a carbon fiber catalyst in a microwave oven. The experimental results shown in FIG. 24 were obtained using a “split carbon” setup. The microwave oven was operated at 2.45 GHZ and 1 kW.

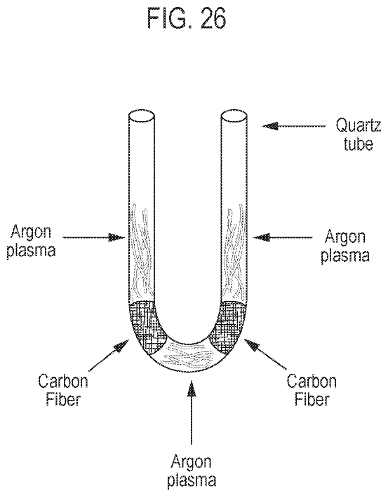

The experiments shown in FIG. 24 utilized two separate bundles of carbon fiber that were packed in a quartz tube similar to the diagram shown in FIG. 26. Without being bound by theory, our hypothesis behind the experiments in FIG. 24 was that two separate bundles of carbon fiber may lead to an increase in conversion efficiency of methane to hydrogen. As shown in FIG. 24, the highest conversion of methane to hydrogen was observed when pure methane was used at a flow rate of 15 cubic centimeters per minute (CCM) over the two bundles of carbon fiber. As shown in FIG. 24, we also performed experiments in which argon was used to fill the space in the quartz tube between the two bundles of carbon fiber. Without being bound by theory, our hypothesis being that we may be able to increase the conversion rate by pairing argon with methane in order to create a plasma in the space between the two carbon bundles. Unfortunately, the argon assisted experiments resulted in a decrease in the conversion efficiency of methane to hydrogen.

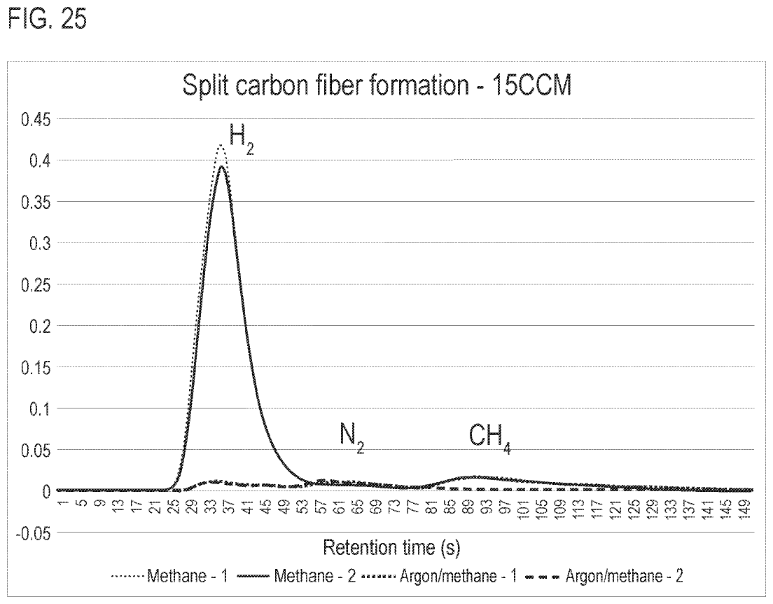

FIG. 25 shows the methane pyrolysis gas chromatography results from a collection of actual methane pyrolysis experiments that were conducted using a carbon fiber catalyst in a microwave oven. The experimental results shown in FIG. 25 were obtained using a “split carbon” setup. The microwave oven was operated at 2.45 GHZ and 1 kW.

The experiments shown in FIG. 25 utilized two separate bundles of carbon fiber that were packed in a quartz tube similar to the diagram shown in FIG. 26. The results shown in FIG. 25 are similar to the results shown in FIG. 24. As shown in FIG. 25, the highest conversion of methane to hydrogen was observed when pure methane was used at a flow rate of 15 cubic meters per minute (CCM) over the two bundles of carbon fiber. As shown in FIG. 25, when mixtures of methane and argon were utilized there was an overall decrease in the conversion of methane to hydrogen.

FIG. 26 is a diagram that explains what is meant by “split carbon” setup, where two separate bundles of carbon fiber were packed in a quartz tube with a space being present between the two bundles of carbon fiber so that the carbon fiber bundles were not in contact with one another. As discussed above, a “split carbon” setup was utilized to perform the experiments discussed in FIG. 24 and FIG. 25 herein. In FIG. 26, the diagram of the “split carbon” setup shows two bundles of carbon fiber separated by plasma generated in an argon atmosphere (i.e., an argon plasma).

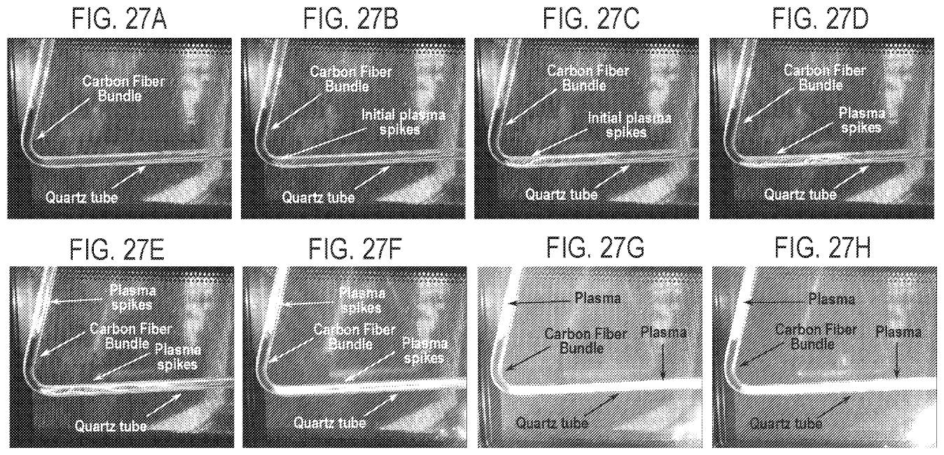

FIG. 27A-FIG. 27H are time-lapse photographs of plasma generation from a single bundle of carbon fiber in a quartz tube filled with argon when subjected to microwave energy in a microwave oven. The carbon fiber used in the experiments shown in FIG. 27A-FIG. 27H possessed a long aspect ratio (i.e., a large length to radius ratio). The microwave oven was operated at 2.45 GHZ and 1 KW. FIG. 27A shows the carbon fiber bundle in the quartz tube filled with argon before being subjected to microwave energy. FIG. 27B shows the initial plasma spikes generated from a first end of the carbon fiber bundle in the presence of argon when subjected to microwave energy. FIG. 27C shows an increase in the size and position of the initial plasma spikes generated from the first end of the carbon fiber bundle in the presence of argon when subjected to microwave energy. FIG. 27D shows a further increase in the size and position of the plasma spikes generated from the first end of the carbon fiber bundle in the presence of argon when subjected to microwave energy. FIG. 27E shows a further increase in the size and position of the plasma spikes generated from the first end of the carbon fiber bundle in the presence of argon when subjected to microwave energy, and also shows plasma spikes generated from a second end of the carbon fiber bundle in the presence of argon when subjected to microwave energy. FIG. 27F shows a further increase in the size and position of the plasma spikes generated from the first end and the second end of the carbon fiber bundle in the presence of argon when subjected to microwave energy. FIG. 27G shows plasma formation at the first end and second end of the carbon fiber bundle in the presence of argon when subjected to microwave energy. FIG. 27H shows FIG. 27G shows plasma at the first end and second end of the carbon fiber bundle in the presence of argon when subjected to microwave energy.

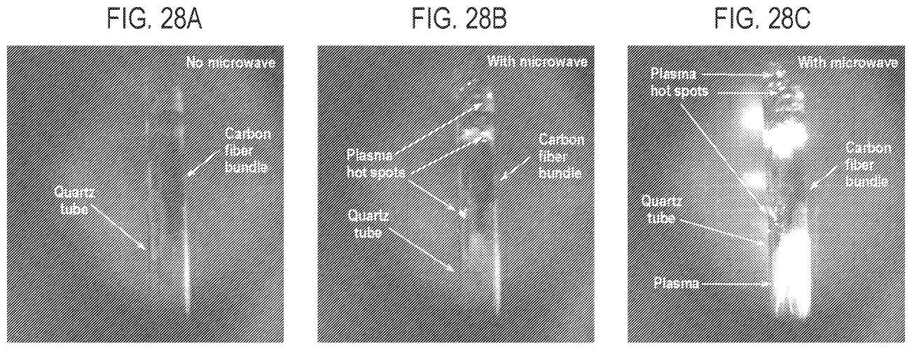

FIG. 28A-FIG. 28C are time-lapse photographs of plasma generation from a single bundle of carbon fiber in a quartz tube filled with methane when subjected to microwave energy in a microwave oven. The microwave oven was operated at 2.45 GHZ and 1 KW. FIG. 28A shows the carbon fiber bundle in the quartz tube filled with methane before being subjected to microwave energy. FIG. 28B shows the initial plasma hot spots generated within the carbon fiber bundle or from a surface of the carbon fiber bundle in the presence of methane when subjected to microwave energy. FIG. 28C shows an increase in the quantity, size, and position of plasma hot spots (thermal hot spots) generated within the carbon fiber bundle or from the surface of the carbon fiber bundle in the presence of methane when subjected to microwave energy. FIG. 28C also shows plasma formation from within the carbon fiber bundle or from a surface of the carbon fiber bundle in the presence of methane when subjected to microwave energy.

### Various Embodiments of the Invention

As discussed above herein, methane pyrolysis is one of the most promising methane reforming methods to produce hydrogen because the process only generates hydrogen and solid carbon, and thus, the formation of CO₂ is prevented during the reaction. The CO₂ emissions from methane pyrolysis are significantly lower than other methane reforming techniques, and the carbon footprint could be zero if renewable energy is used for production. In addition, methane pyrolysis is a one-step process, while SMR needs an extra step (water-gas shift reaction) to generate additional hydrogen and convert the CO to CO₂. In practice, the thermal energy required to initiate and sustain methane pyrolysis has generally been supplied via conventional heating, which has a relatively low efficiency. The materials, methods, systems, and catalysts of the present invention, as provided and described herein, for example, in various embodiments and examples provide much needed improvements to hydrocarbon reforming (including hydrocarbon pyrolysis), including but not limited to methane reforming (including methane pyrolysis).

As provided and discussed herein, in various embodiments of the present invention, microwave heating can form localized thermal hot spots (micro-plasma) that exhibit higher temperature than other regions, which has shown advantageous over conventional heating in catalytic methane reforming. The selective heating properties of microwave allows us to concentrate the electromagnetic energy on specific spots, such as the catalyst surface, leading to a more efficient energy transfer and improved conversion rate. A key advantage of present invention over known methods is our ability to design and fabricate the catalyst structure's geometry and materials to control and manipulate the microwave adsorption to reach highly efficient energy conversion (from microwave energy to heat). This gives us ways to manipulate the temperature distribution and further improve the catalytic reaction efficiency.

In some embodiments, microwave hydrocarbon reforming enables the conversion of fossil fuels (e.g., hydrocarbons) into low-cost hydrogen and carbon. In some embodiments, without being bound by theory, compared to conventional heating, microwave heating is more efficient, because microwave heating enables the formation of localized thermal hot spots, which in turn enables the formation of a microwave plasma which allows for higher temperatures than what is generally obtained by conventional heating. In some embodiments, without being bound by theory, microwave heating is generally considered to be: (i) noncontact heating; (ii) a transfer of energy instead of a transfer of heat; (iii) rapid heating; (iv) selective material heating; and/or (v) quick to start-up and stop. In some embodiments, without being bound by theory, microwave hydrocarbon reforming will provide improvements over conventional hydrocarbon reforming (e.g., conventional methane reforming), where examples of such improvements include but are not limited to (i) enhanced conversion or product formation; (ii) improved yield performance; (iii) and suppression of coke deposition. In some embodiments, without being bound by theory, microwave hydrocarbon reforming enables (a) highly-efficient microwave heating; (b) time-saving capability; (c) high conversion efficiency; and/or (d) environmental compatibility. In some embodiment.

In some embodiments, without being bound by theory, microwave heating enables the control and generation of a localized temperature distribution (e.g., formation of localized thermal hot spots) which in turn enables the control and generation of a localized plasma (e.g., microwave plasma) having a high temperature. In some embodiments, without being bound by theory, microwave heating can be used to promote/perform gaseous reactions and/or gaseous catalytic reactions.

In some embodiments, without being bound by theory, microwave heating enables direct heating, volumetric heating, instantaneous heating, and/or selective heating. In some embodiments, without being bound by theory, microwave heating enables direct heating, for example, where direct heating can occur: (i) on a catalyst surface; (ii) enable absorbed gas species to be reactive; and/or (iii) easily dissociate from an active site.

In some embodiments, without being bound by theory, microwave heating enables volumetric heating, for example, where volumetric heating enables (a) heating to begin from the inside of a material being heated, where the heat moves from the inside to the outside of the material being heated; and (b) a uniform temperature distribution throughout the material being heated.

In some embodiments, without being bound by theory, microwave heating enables instantaneous heating, for example, where instantaneous heating enables (a) a rapid temperature rise; and (b) a reduced reaction time.

In some embodiments, without being bound by theory, microwave heating enables selective heating, for example, of various materials, such as transparent materials (e.g., ceramics, quartz), reflectors (e.g., metals), and/or adsorbers (e.g., lossy materials, carbon). In some embodiments, without being bound by theory, microwave heating enables selective heating, which further enables the control and generation of a localized temperature distribution (e.g., formation of localized thermal hot spots) which in turn enables the control and generation of a localized plasma (e.g., microwave plasma), both of which can be controlled by material and/or structural design. In some embodiments, without being bound by theory, a catalyst having a micro/nano structure could generate a micro-plasma, where the micro-plasma could be generated in a very localized area/volume and at a high temperature, and used to control the localized temperature.

In various embodiments, without being bound by theory, the present invention provides catalyst comprising a three-dimensional structure, having any geometry, and a material composition to increase microwave energy adsorption efficiency, improve plasma (e.g., microwave plasma) generation efficiency, and to improve the conversion efficiency and transfer of microwave energy into heat.

In various embodiments, the present invention provides various catalyst designs including without limitation, metal-based catalysts and carbon-based catalysts. In some embodiments, the metal-based catalysts are three-dimensional metal-based catalysts or three-dimensional metal-based catalyst materials. In some embodiments, the carbon-based catalysts are three-dimensional based catalysts or three-dimensional carbon-based catalyst materials. In some embodiments, non-limiting examples of metal-based catalysts include nickel, cobalt, iron, copper, and combinations thereof (i.e., any alloys thereof). In some embodiments, the metal-based catalyst may comprise a support or be positioned or placed on a support (e.g., a solid support), where non-limiting examples of supports include carbon nanofibers, SiO₂, TiO₂, Al₂O₃, MgO. In some embodiments, non-limiting examples of metal-based catalysts include cobalt-molybdenum on aluminum oxide, ruthenium on titanium dioxide, and platinum on aluminum oxide. In some embodiments, non-limiting examples of carbon-based catalysts include active carbon, carbon black, charcoal, coal, and biomass-derived carbon. In some embodiments, without being limited by theory, carbon-based catalysts have several benefits including without limitation (a) good microwave adsorption capability; (b) low-cost; and (c) corrosion resistance.

In various embodiments, the catalyst or catalyst material comprises a three-dimensional support (e.g., a three-dimensional catalyst support, or three-dimensional catalyst support structure). Without being bound by theory, the three-dimensional support will allow for high efficiency microwave plasma generation. Without being bound by theory, the three-dimensional support may be prepared using various techniques, including but not limited to metal 3D printing, laser sintering, and direct metal laser sintering. Non-limiting examples of direct metal laser sintering materials include aluminum, aluminum alloy (e.g., AlSi10Mg), stainless steel (e.g., stainless steel 17-4, stainless steel 316/L), maraging steel (e.g., maraging steel MS1), nickel-alloy (e.g., nickel-chromium alloy such as Inconel® 625), titanium, titanium-alloy, and titanium-aluminum-vanadium alloy (Ti64). In some embodiments, the three-dimensional support is porous. In some embodiments, the three-dimensional support is a nickel form or 3D printed structure.

In some embodiments, without being bound by theory, it will be advantageous to remove the generated carbon (e.g., coke) formed during microwave hydrocarbon reforming (e.g., microwave hydrocarbon pyrolysis, microwave methane pyrolysis). In some embodiments, without being bound by theory, the generated carbon (e.g., coke) formed during microwave reforming may be removed, for example, from a microwave hydrocarbon reforming system, by the application of microwave energy and microwave plasma in the presence of oxygen, or with microwave heating, or by using microwave heating or energy to promote coke oxidation.

In various embodiments, the present invention provides for various hydrocarbon reforming reactions to be performed. Non-limiting examples of hydrocarbon reforming reactions that may be performed by various embodiments of the present invention include the following:
Steam reforming of methane: CH₄+H₂O↔3H₂+CO (ΔH₂₉₈=+206 kJ/mol).
Dry reforming of methane: CH₄+CO₂↔2H₂+2CO (ΔH₂₉₈=+247 kJ/mol)
Partial oxidation: CH₄+½O₂↔2H₂+CO (ΔH₂₉₈=−8.5 kJ/mol)
Thermal decomposition of methane: CH₄↔C+2H₂ (ΔH₂₉₈=+275 kJ/mol).

In some embodiments, microwave heating is microwave-assisted heating. In some embodiments, microwave reforming is microwave-assisted reforming. In some embodiments, microwave pyrolysis is microwave-assisted pyrolysis. In some embodiments, microwave reforming of hydrocarbons is microwave-assisted reforming of hydrocarbons. In some embodiments, microwave pyrolysis of hydrocarbons is microwave-assisted pyrolysis of hydrocarbons. In some embodiments, microwave hydrocarbon reforming is microwave-assisted hydrocarbon reforming. In some embodiments, microwave hydrocarbon pyrolysis is microwave-assisted hydrocarbon pyrolysis.

Additional embodiments include those listed below:
Embodiment 1. A catalyst for microwave reforming of hydrocarbons, comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy.
Embodiment 2. The catalyst of embodiment 1, wherein the three-dimensional structure comprises any geometry.
Embodiment 3. The catalyst of embodiment 1 or embodiment 2, wherein the three-dimensional structure is configured to maximize the temperature of the localized thermal hot spot.
Embodiment 4. The catalyst of any one of embodiments 1-3, wherein the three-dimensional structure is configured to form a microwave plasma when subjected to microwave energy.
Embodiment 5. The catalyst of embodiment 4, wherein the three-dimensional structure is configured to maximize the temperature of the microwave plasma.
Embodiment 6. The catalyst of any one of embodiments 1-3, wherein the localized thermal hot spot is positioned or configured to form a microwave plasma.
Embodiment 7. The catalyst of embodiment 6, wherein the localized thermal hot spot is positioned or configured to maximize the temperature of the microwave plasma.
Embodiment 8. The catalyst of any one of embodiments 1-7, wherein the catalyst body comprises a three-dimensional support.
Embodiment 9. The catalyst of embodiment 8, wherein the three-dimensional support is porous.
Embodiment 10. The catalyst of embodiment 8 or embodiment 9, wherein the three-dimensional support is selected from a three-dimensional carbon-based support, and a three-dimensional metal-based support, or combination thereof.
Embodiment 11. The catalyst of embodiment 10, wherein the three-dimensional metal-based support comprises at least one selected from the group consisting of aluminum, stainless steel, maraging steel, nickel alloy, titanium, aluminum alloy, cobalt alloy, and titanium alloy.
Embodiment 12. The catalyst of any one of embodiments 1-11, wherein the catalyst material is selected from the group consisting of a carbon-based catalyst material, and a metal-based catalyst material, or a combination thereof.
Embodiment 13. The catalyst of embodiment 12, wherein the carbon-based catalyst material comprises at least one selected from the group consisting of carbon foam, active carbon, carbon black, charcoal, coal, and biomass-derived carbon.
Embodiment 14. The catalyst of embodiment 12, wherein the metal-based catalyst material comprises at least one transition metal.
Embodiment 15. The catalyst of embodiment 14, wherein the at least one transition metal is on a solid support.
Embodiment 16. The catalyst of embodiment 14 or embodiment 15, wherein the at least one transition metal is selected from the group consisting of nickel, cobalt, iron, copper, molybdenum, ruthenium, and platinum, or any combination thereof.
Embodiment 17. The catalyst of embodiment 15 or embodiment 16, wherein the solid support is selected from carbon nanofiber, silicon dioxide (SiO₂), titanium dioxide (TiO₂), aluminum oxide (Al₂O₃), and magnesium oxide (MgO).
Embodiment 18. The catalyst of any one of embodiments 8-17, wherein the catalyst material is in communication with the three-dimensional support.
Embodiment 19. The catalyst of embodiment 12, wherein the metal-based catalyst material is selected from cobalt-molybdenum on aluminum oxide, ruthenium on titanium dioxide, and platinum on aluminum oxide.
Embodiment 20. The catalyst of any one of embodiments 1-19, wherein the hydrocarbons are natural gas or the hydrocarbons comprise natural gas.
Embodiment 21. The catalyst of any one of embodiments 1-19, wherein the hydrocarbons are methane or the hydrocarbons comprise methane.
Embodiment 22. A system for microwave reforming of hydrocarbons, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.
Embodiment 23. The system of embodiment 22, further comprising a carbon separator in communication with the at least one outlet port.
Embodiment 24. The system of embodiment 22 or embodiment 23, further comprising a dryer, wherein the dryer is in communication with the at least one outlet port.
Embodiment 25. The system of any one of embodiments 22-24, further comprising a hydrogen separator, wherein the hydrogen separator is in communication with the at least one outlet port.
Embodiment 26. The system of any one of embodiments 22-25, wherein the three-dimensional catalyst material comprises any geometry.
Embodiment 27. The system of any one of embodiments 22-26, wherein the three-dimensional catalyst material is configured to form a microwave plasma when subjected to microwave energy.
Embodiment 28. The system of embodiment 27, wherein the three-dimensional catalyst material is configured to maximize the temperature of the microwave plasma.
Embodiment 29. The system of any one of embodiments 22-25, wherein the three-dimensional catalyst material comprises any geometry.
Embodiment 30. The system of any one of embodiments 22-25 or 29, wherein the three-dimensional catalyst material is configured to form a localized thermal hot spot within the three-dimensional catalyst material or on a surface of the three-dimensional catalyst material when subjected to microwave energy.
Embodiment 31. The system of embodiment 30, wherein the three-dimensional catalyst material is configured to maximize the temperature of the localized thermal hot spot.
Embodiment 32. The system of embodiment 30 or embodiment 31, wherein the localized thermal hot spot is positioned or configured to form a microwave plasma.
Embodiment 33. The system of embodiment 32, wherein the localized thermal hot spot is positioned or configured to maximize the temperature of the microwave plasma.
Embodiment 34. The system of any one of embodiments 22-33, wherein the three-dimensional catalyst material comprises a three-dimensional support.
Embodiment 35. The system of embodiment 34, wherein the three-dimensional support is porous.
Embodiment 36. The system of embodiment 34 or embodiment 35, wherein the three-dimensional support comprises any geometry.
Embodiment 37. The system of any one of embodiments 34-36, wherein the three-dimensional support is configured to form a localized thermal hot spot within the three-dimensional catalyst material or on a surface of the three-dimensional catalyst material.
Embodiment 38. The system of embodiment 37, wherein the three-dimensional support is configured to maximize the temperature of the localized thermal hot spot.
Embodiment 39. The system of embodiment 37 or embodiment 38, wherein the localized thermal hot spot is positioned or configured to form a microwave plasma.
Embodiment 40. The system of embodiment 39, wherein the localized thermal hot spot is positioned or configured to maximize the temperature of the microwave plasma.
Embodiment 41. The system of any one of embodiments 34-40, wherein the three-dimensional support is selected from a three-dimensional carbon-based support, and a three-dimensional metal-based support, or combination thereof.
Embodiment 42. The system of embodiment 41, wherein the three-dimensional metal-based support comprises at least one selected from the group consisting of aluminum, stainless steel, maraging steel, nickel alloy, titanium, aluminum alloy, cobalt alloy, and titanium alloy.
Embodiment 43. The system of any one of embodiments 18-42, wherein the three-dimensional catalyst material is selected from the group consisting of a three-dimensional carbon-based catalyst material, and a three-dimensional metal-based catalyst material, or a combination thereof.
Embodiment 44. The system of embodiment 43, wherein the three-dimensional carbon-based catalyst material comprises at least one carbon-based catalyst selected from the group consisting of carbon foam, active carbon, carbon black, charcoal, coal, and biomass-derived carbon.
Embodiment 45. The system of embodiment 43, wherein the three-dimensional metal-based catalyst material comprises at least one metal-based catalyst, wherein the at least one-metal based catalyst comprises at least one transition metal.
Embodiment 46. The system of embodiment 45, wherein the at least one transition metal is on a solid support.
Embodiment 47. The system of embodiment 45 or embodiment 46, wherein the at least one transition metal is selected from the group consisting of nickel, cobalt, iron, copper, molybdenum, ruthenium, and platinum, or any combination thereof.
Embodiment 48. The system of embodiment 46 or embodiment 47, wherein the solid support is selected from carbon nanofiber, silicon dioxide (SiO₂), titanium dioxide (TiO₂), aluminum oxide (Al₂O₃), and magnesium oxide (MgO).
Embodiment 49. The system of embodiment 43, wherein the three-dimensional metal-based catalyst material is selected from cobalt-molybdenum on aluminum oxide, ruthenium on titanium dioxide, and platinum on aluminum oxide.
Embodiment 50. The system of any one of embodiments 22-49, wherein the hydrocarbons are natural gas or the hydrocarbons comprise natural gas.
Embodiment 51. The system of any one of embodiments 22-49, wherein the hydrocarbons are methane or the hydrocarbons comprise methane.
Embodiment 52. The system of any one of embodiments 22-49, wherein the microwave reforming of hydrocarbons is microwave pyrolysis of hydrocarbons.
Embodiment 53. The system of any one of embodiments 22-49, wherein the microwave reforming of hydrocarbons is microwave pyrolysis of natural gas.
Embodiment 54. The system of any one of embodiments 22-49, wherein the microwave reforming of hydrocarbons is microwave pyrolysis of methane.
Embodiment 55. A method for microwave reforming of hydrocarbons, comprising: providing a system of any one of embodiments 22-49; contacting the three-dimensional catalyst material with microwave energy to generate a microwave plasma in the reaction chamber; adding a hydrocarbon feedstock to the reaction chamber via the at least one input port; contacting the hydrocarbon feedstock with the microwave plasma in the reaction chamber; and reforming the hydrocarbon feedstock with the microwave plasma to produce hydrogen.
Embodiment 56. The method of embodiment 55, wherein the microwave plasma is a microplasma.
Embodiment 57. The method of embodiment 55 or embodiment 56, wherein the hydrocarbon feedstock is methane or the hydrocarbon feedstock comprises methane.
Embodiment 58. The method of embodiment 55 or embodiment 56, wherein the hydrocarbon feedstock is natural gas or the hydrocarbon feedstock comprises natural gas.
Embodiment 59. The method of any one of embodiments 55-58, wherein the hydrocarbon feedstock further comprises at least one selected from the group consisting of carbon dioxide and water, or a combination thereof.
Embodiment 60. The method of embodiment 55 or embodiment 56, wherein the microwave reforming of hydrocarbons is microwave pyrolysis of hydrocarbons.
Embodiment 61. The method of embodiment 55 or embodiment 56, wherein the microwave reforming of hydrocarbons is microwave pyrolysis of natural gas.
Embodiment 62. The method of embodiment 55 or embodiment 56, wherein the microwave reforming of hydrocarbons is microwave pyrolysis of methane.
Embodiment 63. A method for microwave pyrolysis of hydrocarbons, comprising: providing a system of any one of embodiments 22-49; contacting the three-dimensional catalyst material with microwave energy to generate a microwave plasma in the reaction chamber, adding a hydrocarbon feedstock to the reaction chamber via the at least one input port; contacting the hydrocarbon feedstock with the microwave plasma in the reaction chamber, and pyrolyzing the hydrocarbon feedstock with the microwave plasma to produce hydrogen.
Embodiment 64. The method of embodiment 63, wherein the microwave plasma is a microplasma.
Embodiment 65. The method of embodiment 63 or embodiment 64, wherein the hydrocarbon feedstock is methane or the hydrocarbon feed stock comprises methane.
Embodiment 66. The method of embodiment 63 or embodiment 64, wherein the hydrocarbon feedstock is natural gas or the hydrocarbon feedstock comprises natural gas.
Embodiment 67. A method for microwave reforming of hydrocarbons, comprising: providing a catalyst of any one of embodiments 1-19; contacting the catalyst with microwave energy to generate a microwave plasma; contacting a hydrocarbon feedstock with the microwave plasma; and reforming the hydrocarbon feedstock with the microwave plasma to produce hydrogen.
Embodiment 68. The method of embodiment 67, wherein the microwave plasma is a microplasma.
Embodiment 69. The method of embodiment 67 or embodiment 68, wherein the hydrocarbon feedstock is methane or the hydrocarbon feedstock comprises methane.
Embodiment 70. The method of embodiment 67 or embodiment 68, wherein the hydrocarbon feedstock is natural gas or the hydrocarbon feedstock comprises natural gas.
Embodiment 71. The method of any one of embodiments 67-70, wherein the hydrocarbon feedstock further comprises at least one selected from the group consisting of carbon dioxide and water, or a combination thereof.
Embodiment 72. The method of embodiment 67 or embodiment 68, wherein the microwave reforming of hydrocarbons is microwave pyrolysis of hydrocarbons.
Embodiment 73. The method of embodiment 67 or embodiment 68, wherein the microwave reforming of hydrocarbons is microwave pyrolysis of natural gas.
Embodiment 74. The method of embodiment 67 or embodiment 68, wherein the microwave reforming of hydrocarbons is microwave pyrolysis of methane.
Embodiment 75. A method for microwave pyrolysis of hydrocarbons, comprising: providing a catalyst of any one of embodiments 1-19; contacting the catalyst with microwave energy to generate a microwave plasma; contacting a hydrocarbon feedstock with the microwave plasma; and pyrolyzing the hydrocarbon feedstock with the microwave plasma to produce hydrogen.
Embodiment 76. The method of embodiment 75, wherein the microwave plasma is a microplasma.
Embodiment 77. The method of embodiment 75 or embodiment 76, wherein the hydrocarbon feedstock is methane or the hydrocarbon feedstock comprises methane.
Embodiment 78. The method of embodiment 75 or embodiment 76, wherein the hydrocarbon feedstock is natural gas or the hydrocarbon feedstock comprises natural gas.

Additional embodiments include those listed below:

In various embodiments, the present invention provides a catalyst system for microwave reforming of hydrocarbons, comprising: a three-dimensional support; and at least one catalyst. In various embodiments, the present invention provides a catalyst system for microwave pyrolysis of methane, comprising: a three-dimensional support; and at least one catalyst.

In various embodiments, the present invention provides a catalyst system for microwave production of hydrogen from hydrocarbons, comprising: a three-dimensional support; and at least one catalyst.

In various embodiments, the present invention provides a catalyst system for microwave production of hydrogen from at least one hydrocarbon, comprising: a three-dimensional support; and at least one catalyst.

In various embodiments, the present invention provides a catalyst system for microwave production of hydrogen from natural gas, comprising: a three-dimensional support; and at least one catalyst.

In various embodiments, the present invention provides a catalyst system for microwave production of hydrogen from a hydrocarbon feedstock, comprising: a three-dimensional support; and at least one catalyst.

In various embodiments, the present invention provides a catalyst system for microwave production of hydrogen from methane, comprising: a three-dimensional support; and at least one catalyst.

In some embodiments, the catalyst is a carbon-based catalyst, a metal-based catalyst, or a combination thereof. In some embodiments, the carbon-based catalyst comprises at least one selected from the group consisting of carbon foam, carbon fiber, active carbon, carbon black, charcoal, coal, biomass-derived carbon, and any combination thereof. In some embodiments, the metal-based catalyst comprises at least one transition metal.

In some embodiments, the catalyst comprises at least one transition metal. In some embodiments, the catalyst is at least one transition metal. In some embodiments, the at least one transition metal is selected from the group consisting of nickel, cobalt, iron, copper, molybdenum, ruthenium, platinum, and any combination thereof.

In some embodiments, the at least one transition metal is on a solid support. In some embodiments, the at least one transition metal is attached to a solid support. In some embodiments, the solid support is selected from carbon nanofiber, silicon dioxide (SiO₂), titanium dioxide (TiO₂), aluminum oxide (Al₂O₃), and magnesium oxide (MgO).

In some embodiment, the catalyst is on a solid support. In some embodiments, the catalyst is attached to a solid support.

In some embodiments, the solid support is on the three-dimensional support. In some embodiments, the solid support is attached to the three-dimensional support.

In some embodiments, the at least one catalyst is attached to the three-dimensional support. In some embodiments, the at least one catalyst is on the three-dimensional support. In some embodiments, the at least one catalyst is electrochemically deposited on the three-dimensional support. In some embodiments, the at least one catalyst comprises carbon, a carbon-based material, at least one transition metal, or combination thereof. In some embodiments, the at least one catalyst is at least one transition metal. In some embodiments, the at least one transition metal is selected from the group consisting of nickel, cobalt, iron, copper, molybdenum, ruthenium, platinum, and any combination thereof. In some embodiments, the at least one transition metal is on the three-dimensional support.

In some embodiments, the three-dimensional support is porous or comprises a porous material. In some embodiments, the three-dimensional support is selected from a three-dimensional carbon-based support, and a three-dimensional metal-based support, or combination thereof. In some embodiments, the three-dimensional metal-based support comprises at least one selected from the group consisting of aluminum, stainless steel, maraging steel, nickel alloy, titanium, aluminum alloy, cobalt alloy, and titanium alloy. In some embodiments, the three-dimensional carbon-based support comprises at least one selected from the group consisting of carbon foam, carbon fiber, active carbon, carbon black, charcoal, coal, and biomass-derived carbon.

In some embodiments, the three-dimensional support is configured to form a localized thermal hot spot within the three-dimensional support or on a surface of the three-dimensional support when subjected to microwave energy.

In some embodiments, the three-dimensional support is configured to form a thermal hot spot within the three-dimensional support or on a surface of the three-dimensional support when subjected to microwave energy.

In some embodiments, the three-dimensional support is configured to maximize the temperature of the localized thermal hot spot. In some embodiments, the three-dimensional support is configured to form a microwave plasma when subjected to microwave energy. In some embodiments, the three-dimensional support is configured to maximize the temperature of the microwave plasma. In some embodiments, the localized thermal hot spot is positioned or configured to form a microwave plasma. In some embodiments, the localized thermal hot spot is positioned or configured to maximize the temperature of the microwave plasma.

In some embodiments, the three-dimensional support is configured to maximize the temperature of the thermal hot spot. In some embodiments, the three-dimensional support is configured to form a microwave plasma when subjected to microwave energy. In some embodiments, the three-dimensional support is configured to maximize the temperature of the microwave plasma. In some embodiments, the thermal hot spot is positioned or configured to form a microwave plasma. In some embodiments, the thermal hot spot is positioned or configured to maximize the temperature of the microwave plasma.

In some embodiments, the three-dimensional support is configured to form a localized thermal hot spot within the catalyst, in proximity to the catalyst, or on a surface of the catalyst when subjected to microwave energy.

In some embodiments, the three-dimensional support is configured to form a thermal hot spot within the catalyst, in proximity to the catalyst, or on a surface of the catalyst when subjected to microwave energy.

In some embodiments, the three-dimensional support is configured to maximize the temperature of the localized thermal hot spot within the catalyst, in proximity to the catalyst, or on a surface of the catalyst. In some embodiments, the three-dimensional support is configured to form a microwave plasma within the catalyst, in proximity to the catalyst, in combination with the catalyst, or on a surface of the catalyst when subjected to microwave energy. In some embodiments, the three-dimensional support is configured to maximize the temperature of the microwave plasma within the catalyst, in proximity to the catalyst, in combination with the catalyst, or on a surface of the catalyst. In some embodiments, the localized thermal hot spot is positioned or configured to form a microwave plasma within the catalyst, in proximity to the catalyst, in combination with the catalyst, or on a surface of the catalyst. In some embodiments, the localized thermal hot spot is positioned or configured to maximize the temperature of the microwave plasma within the catalyst, in proximity to the catalyst, in combination with the catalyst, or on a surface of the catalyst.

In some embodiments, the three-dimensional support is configured to maximize the temperature of the thermal hot spot within the catalyst, in proximity to the catalyst, or on a surface of the catalyst. In some embodiments, the three-dimensional support is configured to form a microwave plasma within the catalyst, in proximity to the catalyst, in combination with the catalyst, or on a surface of the catalyst when subjected to microwave energy. In some embodiments, the three-dimensional support is configured to maximize the temperature of the microwave plasma within the catalyst, in proximity to the catalyst, in combination with the catalyst, or on a surface of the catalyst. In some embodiments, the thermal hot spot is positioned or configured to form a microwave plasma within the catalyst, in proximity to the catalyst, in combination with the catalyst, or on a surface of the catalyst. In some embodiments, the thermal hot spot is positioned or configured to maximize the temperature of the microwave plasma within the catalyst, in proximity to the catalyst, in combination with the catalyst, or on a surface of the catalyst.

In some embodiments, the three-dimensional support comprises any geometry. In some embodiments, the geometry is a cylinder, cone, prism, pyramid, sphere, cube, cuboid, triangular prism, polyhedron, icosahedron, torus, ellipsoid, rectangular cuboid, square pyramid, or tetrahedron. In some embodiments, the three-dimensional support comprises any geometrical shape. In some embodiments, the geometrical shape is a cylinder, cone, prism, pyramid, sphere, cube, cuboid, triangular prism, polyhedron, icosahedron, torus, ellipsoid, rectangular cuboid, square pyramid, or tetrahedron.

In some embodiments, the three-dimensional support is a three-dimensional framework. In some embodiments, the three-dimensional support is a three-dimensional structure. In some embodiments, the three-dimensional structure is a three-dimensional framework.

In some embodiments, the catalyst body is porous.

In some embodiments, catalyst body comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the catalyst body is carbon fiber or comprises carbon fiber. In some embodiments, the catalyst body comprises carbon foam. In some embodiments, the catalyst body is carbon foam.

In some embodiments, the metal-based material comprises at least one of aluminum, stainless steel, maraging steel, nickel alloy, titanium, aluminum alloy, cobalt alloy, or titanium alloy.

In some embodiments, the three-dimensional support is porous.

In some embodiments, the three-dimensional support comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the three-dimensional support is carbon fiber or comprises carbon fiber. In some embodiments, the three-dimensional support comprises carbon foam. In some embodiments, the three-dimensional support is carbon foam.

In some embodiments, the metal-based material comprises at least one of aluminum, stainless steel, maraging steel, nickel alloy, titanium, aluminum alloy, cobalt alloy, or titanium alloy.

In some embodiments, the catalyst system is configured to reduce coke formation. In some embodiments, the catalyst is configured to reduce coke formation. In some embodiments, the catalyst body is configured to reduce coke formation. In some embodiments, the catalyst material is configured to reduce coke formation.

In some embodiments, the catalyst system reduces coke formation. In some embodiments, the catalyst reduces coke formation. In some embodiments, the catalyst body reduces coke formation. In some embodiments, the catalyst material reduces coke formation.

Additional embodiments include those listed below:

In various embodiments, the present invention provides a catalyst for microwave reforming of hydrocarbons, comprising: a catalyst body comprising at least one catalyst material, wherein the catalyst body has a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave reforming of hydrocarbons, comprising: a catalyst body comprising at least one catalyst material, wherein the catalyst body has a three-dimensional structure, and wherein the three-dimensional structure is configured to form a thermal hot spot within the catalyst body or on a surface of the catalyst body when subjected to microwave energy.

In various embodiments, the present invention provides a catalyst for microwave reforming of hydrocarbons, comprising: a catalyst body comprising at least one catalyst material, wherein the catalyst body comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave reforming of hydrocarbons, comprising: a catalyst body comprising at least one catalyst material, wherein the catalyst body comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from hydrocarbons, comprising: a catalyst body comprising at least one catalyst material, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from hydrocarbons, comprising: a catalyst body comprising at least one catalyst material, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from at least one hydrocarbon, comprising: a catalyst body comprising at least one catalyst material, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from at least one hydrocarbon, comprising: a catalyst body comprising at least one catalyst material, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from natural gas, comprising: a catalyst body comprising at least one catalyst material, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from natural gas, comprising: a catalyst body comprising at least one catalyst material, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from methane, comprising: a catalyst body comprising at least one catalyst material, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from methane, comprising: a catalyst body comprising at least one catalyst material, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from a hydrocarbon feedstock, comprising: a catalyst body comprising at least one catalyst material, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from a hydrocarbon feedstock, comprising: a catalyst body comprising at least one catalyst material, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave pyrolysis of methane, comprising: a catalyst body comprising at least one catalyst material, wherein the catalyst body has a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave pyrolysis of methane, comprising: a catalyst body comprising at least one catalyst material, wherein the catalyst body has a three-dimensional structure, and wherein the three-dimensional structure is configured to form a thermal hot spot within the catalyst body or on a surface of the catalyst body when subjected to microwave energy.

In various embodiments, the present invention provides a catalyst for microwave pyrolysis of methane, comprising: a catalyst body comprising at least one catalyst material, wherein the catalyst body comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave pyrolysis of methane, comprising: a catalyst body comprising at least one catalyst material, wherein the catalyst body comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave reforming of hydrocarbons, comprising: a catalyst body, wherein the catalyst body comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave reforming of hydrocarbons, comprising: a catalyst body, wherein the catalyst body comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave reforming of hydrocarbons, comprising: a catalyst body, wherein the catalyst body has a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave reforming of hydrocarbons, comprising: a catalyst body, wherein the catalyst body has a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from hydrocarbons, comprising: a catalyst body, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from hydrocarbons, comprising: a catalyst body, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from at least one hydrocarbon, comprising: a catalyst body, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from at least one hydrocarbon, comprising: a catalyst body, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from natural gas, comprising: a catalyst body, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from natural gas, comprising: a catalyst body, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from methane, comprising: a catalyst body, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from methane, comprising: a catalyst body, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave production of hydrogen from a hydrocarbon feedstock, comprising: a catalyst body, wherein the catalyst body has or comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave production of hydrogen from a hydrocarbon feedstock, comprising: a catalyst body, wherein the catalyst body has or comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave pyrolysis of methane, comprising: a catalyst body, wherein the catalyst body comprises a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave pyrolysis of methane, comprising: a catalyst body, wherein the catalyst body comprises a three-dimensional structure, and wherein the three-dimensional structure is configured to form a thermal hot spot within the catalyst body or on a surface of the catalyst body when subjected to microwave energy.

In various embodiments, the present invention provides a catalyst for microwave pyrolysis of methane, comprising: a catalyst body, wherein the catalyst body has a three-dimensional structure, and wherein the three-dimensional structure is configured to form a localized thermal hot spot within the catalyst body or on a surface of the catalyst body when subjected to microwave energy.

In various embodiments, the present invention provides a catalyst for microwave pyrolysis of methane, comprising: a catalyst body, wherein the catalyst body has a three-dimensional structure, and wherein the three-dimensional structure is configured to form a thermal hot spot within the catalyst body or on a surface of the catalyst body when subjected to microwave energy.

In some embodiments, the three-dimensional structure comprises any geometry. In some embodiments, the geometry is a cylinder, cone, prism, pyramid, sphere, cube, cuboid, triangular prism, polyhedron, icosahedron, torus, ellipsoid, rectangular cuboid, square pyramid, or tetrahedron.

In some embodiments, the three-dimensional structure comprises any geometrical shape. In some embodiments, the geometrical shape is a cylinder, cone, prism, pyramid, sphere, cube, cuboid, triangular prism, polyhedron, icosahedron, torus, ellipsoid, rectangular cuboid, square pyramid, or tetrahedron.

In some embodiments, the three-dimensional structure is configured to maximize the temperature of the localized thermal hot spot. In some embodiments, the three-dimensional structure is configured to form a microwave plasma when subjected to microwave energy. In some embodiments, the three-dimensional structure is configured to maximize the temperature of the microwave plasma. In some embodiments, the localized thermal hot spot is positioned or configured to form a microwave plasma. In some embodiments, the localized thermal hot spot is positioned or configured to maximize the temperature of the microwave plasma.

In some embodiments, the three-dimensional structure is configured to maximize the temperature of the thermal hot spot. In some embodiments, the three-dimensional structure is configured to form a microwave plasma when subjected to microwave energy. In some embodiments, the three-dimensional structure is configured to maximize the temperature of the microwave plasma. In some embodiments, the thermal hot spot is positioned or configured to form a microwave plasma. In some embodiments, the thermal hot spot is positioned or configured to maximize the temperature of the microwave plasma.

In some embodiments, the catalyst body comprises a carbon-based material, a metal-based material, or combination thereof. In some embodiments, the carbon-based material is selected from the group consisting of carbon foam, carbon fiber, active carbon, carbon black, charcoal, coal, and biomass-derived carbon. In some embodiments, the metal-based material is selected from the group consisting of aluminum, stainless steel, maraging steel, nickel alloy, titanium, aluminum alloy, cobalt alloy, and titanium alloy.

In some embodiments, the catalyst body comprises a three-dimensional support. In some embodiments, the three-dimensional support is porous or comprises a porous material. In some embodiments, the three-dimensional support is selected from a three-dimensional carbon-based support, and a three-dimensional metal-based support, or combination thereof. In some embodiments, the three-dimensional metal-based support comprises at least one selected from the group consisting of aluminum, stainless steel, maraging steel, nickel alloy, titanium, aluminum alloy, cobalt alloy, and titanium alloy. In some embodiments, the three-dimensional carbon-based support comprises at least one selected from the group consisting of carbon foam, carbon fiber, active carbon, carbon black, charcoal, coal, and biomass-derived carbon.

In some embodiments, the catalyst material is selected from the group consisting of a carbon-based catalyst material, and a metal-based catalyst material, or a combination thereof. In some embodiments, the carbon-based catalyst material comprises at least one selected from the group consisting of carbon foam, carbon fiber, active carbon, carbon black, charcoal, coal, and biomass-derived carbon. In some embodiments, the metal-based catalyst material comprises at least one transition metal.

In some embodiments, the catalyst material is a first catalyst material. In some embodiments, the catalyst further comprises at least one other catalyst material. In some embodiments, the first catalyst material and the at least one other catalyst material are the same or different from one another. In some embodiments, each of the at least one other catalyst materials are the same or different from one another.

In some embodiments, the at least one other catalyst material is selected from the group consisting of a carbon-based catalyst material, and a metal-based catalyst material, or a combination thereof. In some embodiments, the carbon-based catalyst material comprises at least one selected from the group consisting of carbon foam, carbon fiber, active carbon, carbon black, charcoal, coal, and biomass-derived carbon. In some embodiments, the metal-based catalyst material comprises at least one transition metal.

In some embodiments, the at least one transition metal is on the three-dimensional solid support. In some embodiments, the at least one transition metal is attached to the three-dimensional support. In some embodiments, the at least one transition metal is selected from the group consisting of nickel, cobalt, iron, copper, molybdenum, ruthenium, platinum, andany combination thereof.

In some embodiments, the three-dimensional support is a three-dimensional framework. In some embodiments, the three-dimensional support is a three-dimensional structure. In some embodiments, the three-dimensional structure is a three-dimensional framework.

In some embodiments, the catalyst body is porous.

In some embodiments, catalyst body comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the catalyst body is carbon fiber or comprises carbon fiber. In some embodiments, the catalyst body comprises carbon foam. In some embodiments, the catalyst body is carbon foam.

In some embodiments, the metal-based material comprises at least one of aluminum, stainless steel, maraging steel, nickel alloy, titanium, aluminum alloy, cobalt alloy, or titanium alloy.

In some embodiments, the three-dimensional support is porous.

In some embodiments, the three-dimensional support comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the three-dimensional support is carbon fiber or comprises carbon fiber. In some embodiments, the three-dimensional support comprises carbon foam. In some embodiments, the three-dimensional support is carbon foam.

In some embodiments, the metal-based material comprises at least one of aluminum, stainless steel, maraging steel, nickel alloy, titanium, aluminum alloy, cobalt alloy, or titanium alloy.

In some embodiments, the catalyst system is configured to reduce or inhibit coke formation. In some embodiments, the catalyst is configured to reduce or inhibit coke formation. In some embodiments, the catalyst body is configured to reduce or inhibit coke formation. In some embodiments, the catalyst material is configured to reduce or inhibit coke formation.

In some embodiments, the catalyst system reduces or inhibits coke formation. In some embodiments, the catalyst reduces or inhibits coke formation. In some embodiments, the catalyst body reduces or inhibits coke formation. In some embodiments, the catalyst material reduces or inhibits coke formation.

Additional embodiments include those listed below:

In various embodiments, the present invention provides a system for microwave reforming of hydrocarbons, comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber.

In various embodiments, the present invention provides a system for microwave production of hydrogen from hydrocarbons, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In various embodiments, the present invention provides a system for microwave production of hydrogen from at least one hydrocarbon, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In various embodiments, the present invention provides a system for microwave production of hydrogen from natural gas, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In various embodiments, the present invention provides a system for microwave production of hydrogen from methane, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In various embodiments, the present invention provides a system for microwave production of hydrogen from a hydrocarbon feedstock, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In various embodiments, the present invention provides a system for microwave pyrolysis of methane, comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber.

In some embodiments, the hydrocarbon or hydrocarbons is natural gas.

In some embodiments, the hydrocarbon or hydrocarbons is methane, ethane, propane, isobutane, n-butane, n-pentane, isopentane, tert-pentane, or any combination thereof. In some embodiments, the hydrocarbon or hydrocarbons is methane, ethane, propane, isobutane, n-butane, or any combination thereof.

In some embodiments, the system for microwave reforming of hydrocarbons further comprises a carbon separator in communication with the at least one outlet port. In some embodiments, the system for microwave pyrolysis of methane further comprises a carbon separator in communication with the at least one outlet port.

In some embodiments, the system for microwave reforming of hydrocarbons further comprises a dryer, wherein the dryer is in communication with the at least one outlet port. In some embodiments, the system for microwave pyrolysis of methane further comprises a dryer, wherein the dryer is in communication with the at least one outlet port.

In some embodiments, the system for microwave reforming of hydrocarbons further comprises a hydrogen separator, wherein the hydrogen separator is in communication with the at least one outlet port. In some embodiments, the system for microwave pyrolysis of methane further comprises a hydrogen separator, wherein the hydrogen separator is in communication with the at least one outlet port.

In some embodiments, the three-dimensional catalyst material comprises any geometry. In some embodiments, the geometry is a cylinder, cone, prism, pyramid, sphere, cube, cuboid, triangular prism, polyhedron, isosahedron, torus, ellipsoid, rectangular cuboid, square pyramid, or tetrahedron.

In some embodiments, the three-dimensional catalyst material comprises any geometrical shape. In some embodiments, the geometrical shape is a cylinder, cone, prism, pyramid, sphere, cube, cuboid, triangular prism, polyhedron, isosahedron, torus, ellipsoid, rectangular cuboid, square pyramid, or tetrahedron.

In some embodiments, the three-dimensional catalyst material is configured to form a microwave plasma when subjected to microwave energy. In some embodiments, the three-dimensional catalyst material is configured to maximize the temperature of the microwave plasma.

In some embodiments, the three-dimensional catalyst material is configured to form a localized thermal hot spot within the three-dimensional catalyst material or on a surface of the three-dimensional catalyst material when subjected to microwave energy.

In some embodiments, the three-dimensional catalyst material is configured to form a thermal hot spot within the three-dimensional catalyst material or on a surface of the three-dimensional catalyst material when subjected to microwave energy.

In some embodiments, the three-dimensional catalyst material is configured to maximize the temperature of the localized thermal hot spot.

In some embodiments, the three-dimensional catalyst material is configured to maximize the temperature of the thermal hot spot.

In some embodiments, the localized thermal hot spot is positioned or configured to form a microwave plasma.

In some embodiments, the thermal hot spot is positioned or configured to form a microwave plasma.

In some embodiments, the localized thermal hot spot is positioned or configured to maximize the temperature of the microwave plasma.

In some embodiments, the thermal hot spot is positioned or configured to maximize the temperature of the microwave plasma.

In some embodiments, the three-dimensional catalyst material comprises a three-dimensional support.

In some embodiments, the three-dimensional support is porous or comprises a porous material.

In some embodiments, the three-dimensional support comprises any geometry. In some embodiments, the geometry is a cylinder, cone, prism, pyramid, sphere, cube, cuboid, triangular prism, polyhedron, isosahedron, torus, ellipsoid, rectangular cuboid, square pyramid, or tetrahedron.

In some embodiments, the three-dimensional support comprises any geometrical shape. In some embodiments, the geometrical shape is a cylinder, cone, prism, pyramid, sphere, cube, cuboid, triangular prism, polyhedron, isosahedron, torus, ellipsoid, rectangular cuboid, square pyramid, or tetrahedron.

In some embodiments, the three-dimensional support is configured to form a localized thermal hot spot within the three-dimensional catalyst material or on a surface of the three-dimensional catalyst material.

In some embodiments, the three-dimensional support is configured to form a thermal hot spot within the three-dimensional catalyst material or on a surface of the three-dimensional catalyst material.

In some embodiments, the three-dimensional support is configured to maximize the temperature of the localized thermal hot spot.

In some embodiments, the three-dimensional support is configured to maximize the temperature of the thermal hot spot.

In some embodiments, the localized thermal hot spot is positioned or configured to form a microwave plasma.

In some embodiments, the thermal hot spot is positioned or configured to form a microwave plasma.

In some embodiments, the localized thermal hot spot is positioned or configured to maximize the temperature of the microwave plasma.

In some embodiments, the thermal hot spot is positioned or configured to maximize the temperature of the microwave plasma.

In some embodiments, the three-dimensional support is selected from a three-dimensional carbon-based support, and a three-dimensional metal-based support, or combination thereof.

In some embodiments, the three-dimensional metal-based support comprises at least one selected from the group consisting of aluminum, stainless steel, maraging steel, nickel alloy, titanium, aluminum alloy, cobalt alloy, and titanium alloy.

In some embodiments, the three-dimensional catalyst material is selected from the group consisting of a three-dimensional carbon-based catalyst material, and a three-dimensional metal-based catalyst material, or a combination thereof.

In some embodiments, the three-dimensional carbon-based catalyst material comprises at least one carbon-based catalyst selected from the group consisting of carbon foam, carbon fiber, active carbon, carbon black, charcoal, coal, and biomass-derived carbon.

In some embodiments, the three-dimensional metal-based catalyst material comprises at least one metal-based catalyst, wherein the at least one-metal based catalyst comprises at least one transition metal.

In some embodiments, the at least one transition metal is on a solid support.

In some embodiments, the at least one transition metal is selected from the group consisting of nickel, cobalt, iron, copper, molybdenum, ruthenium, and platinum, or any combination thereof.

In some embodiments, the solid support is selected from carbon nanofiber, silicon dioxide (SiO₂), titanium dioxide (TiO₂), aluminum oxide (Al₂O₃), and magnesium oxide (MgO).

In some embodiments, the three-dimensional metal-based catalyst material is selected from cobalt-molybdenum on aluminum oxide, ruthenium on titanium dioxide, and platinum on aluminum oxide.

In some embodiments, the hydrocarbons are natural gas or the hydrocarbons comprise natural gas.

In some embodiments, the hydrocarbons are methane or the hydrocarbons comprise methane.

In some embodiments, the microwave reforming of hydrocarbons is microwave pyrolysis of hydrocarbons.

In some embodiments, the microwave reforming of hydrocarbons is microwave pyrolysis of methane.

In some embodiments, the three-dimensional support is porous.

In some embodiments, the three-dimensional support comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the three-dimensional support is carbon fiber or comprises carbon fiber. In some embodiments, the three-dimensional support comprises carbon foam. In some embodiments, the three-dimensional support is carbon foam.

In some embodiments, the metal-based material comprises at least one of aluminum, stainless steel, maraging steel, nickel alloy, titanium, aluminum alloy, cobalt alloy, or titanium alloy.

In some embodiments, the system is configured to reduce or inhibit coke formation. In some embodiments, the catalyst system is configured to reduce or inhibit coke formation. In some embodiments, the catalyst is configured to reduce or inhibit coke formation. In some embodiments, the catalyst body is configured to reduce or inhibit coke formation. In some embodiments, the catalyst material is configured to reduce or inhibit coke formation.

In some embodiments, the system reduces coke formation. In some embodiments, the catalyst system reduces coke formation. In some embodiments, the catalyst reduces coke formation. In some embodiments, the catalyst body reduces coke formation. In some embodiments, the catalyst material reduces coke formation.

Additional embodiments include those listed below:

In various embodiments, the present invention provides a method for microwave reforming of hydrocarbons, comprising: providing a system for microwave reforming of hydrocarbons, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding a hydrocarbon feedstock to the reaction chamber via the at least one input port; contacting the hydrocarbon feedstock with the microwave plasma in the reaction chamber; and reforming the hydrocarbon feedstock with the microwave plasma to produce hydrogen.

In various embodiments, the present invention provides a method for microwave reforming of hydrocarbons, comprising: providing a system for microwave reforming of hydrocarbons, the system comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding a hydrocarbon feedstock to the reaction chamber via the at least one input port; contacting the hydrocarbon feedstock with the microwave plasma in the reaction chamber, and reforming the hydrocarbon feedstock with the microwave plasma to produce at least one product.

In various embodiments, the present invention provides a method for microwave reforming of at least one hydrocarbon, comprising: providing a system for microwave reforming of at least one hydrocarbon, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the at least one hydrocarbon to the reaction chamber via the at least one input port; contacting the at least one hydrocarbon with the microwave plasma in the reaction chamber, and reforming the at least one hydrocarbon with the microwave plasma to produce hydrogen.

In various embodiments, the present invention provides a method for microwave reforming of at least one hydrocarbon, comprising: providing a system for microwave reforming of at least one hydrocarbon, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the at least one hydrocarbon to the reaction chamber via the at least one input port; contacting the at least one hydrocarbon with the microwave plasma in the reaction chamber; and reforming the at least one hydrocarbon with the microwave plasma to produce at least one product.

In various embodiments, the present invention provides a method for microwave reforming of a hydrocarbon feedstock, comprising: providing a system for microwave reforming of the hydrocarbon feedstock, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the hydrocarbon feedstock to the reaction chamber via the at least one input port; contacting the hydrocarbon feedstock with the microwave plasma in the reaction chamber; and reforming the hydrocarbon feedstock with the microwave plasma to produce hydrogen.

In various embodiments, the present invention provides a method for microwave reforming of a hydrocarbon feedstock, comprising: providing a system for microwave reforming of the hydrocarbon feedstock, the system comprising: a reaction chamber, wherein the reaction chamber comprises at least one input port and at least one outlet port, a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the hydrocarbon feedstock to the reaction chamber via the at least one input port; contacting the hydrocarbon feedstock with the microwave plasma in the reaction chamber; and reforming the hydrocarbon feedstock with the microwave plasma to produce at least one product.

In various embodiments, the present invention provides a method for microwave reforming of natural gas, comprising: providing a system for microwave reforming of the natural gas, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the natural gas to the reaction chamber via the at least one input port; contacting the natural gas with the microwave plasma in the reaction chamber, and reforming the natural gas with the microwave plasma to produce hydrogen.

In various embodiments, the present invention provides a method for microwave reforming of natural gas, comprising: providing a system for microwave reforming of the natural gas, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the natural gas to the reaction chamber via the at least one input port; contacting the natural gas with the microwave plasma in the reaction chamber, and reforming the natural gas with the microwave plasma to produce at least one product.

In various embodiments, the present invention provides a method for microwave reforming of methane, comprising: providing a system for microwave reforming of the methane, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the methane to the reaction chamber via the at least one input port; contacting the natural gas with the microwave plasma in the reaction chamber; and reforming the methane with the microwave plasma to produce hydrogen.

In various embodiments, the present invention provides a method for microwave reforming of methane, comprising: providing a system for microwave reforming of the methane, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the methane to the reaction chamber via the at least one input port; contacting the methane with the microwave plasma in the reaction chamber, and reforming the methane with the microwave plasma to produce at least one product.

In various embodiments, the present invention provides a method for microwave production of hydrogen from hydrocarbons, comprising: providing a system for microwave production of hydrogen, the system comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the hydrocarbons to the reaction chamber via the at least one input port; contacting the hydrocarbons with the microwave plasma in the reaction chamber; and producing hydrogen from the hydrocarbons.

In various embodiments, the present invention provides a method for microwave production of hydrogen from at least one hydrocarbon, comprising: providing a system for microwave production of hydrogen, the system comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the at least one hydrocarbon to the reaction chamber via the at least one input port; contacting the at least one hydrocarbon with the microwave plasma in the reaction chamber; and producing hydrogen from the at least one hydrocarbon.

In various embodiments, the present invention provides a method for microwave production of hydrogen from natural gas, comprising: providing a system for microwave production of hydrogen, the system comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the natural gas to the reaction chamber via the at least one input port; contacting the natural gas with the microwave plasma in the reaction chamber; and producing hydrogen from the natural gas.

In various embodiments, the present invention provides a method for microwave production of hydrogen from a hydrocarbon feedstock, comprising: providing a system for microwave production of hydrogen, the system comprising: a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the hydrocarbon feedstock to the reaction chamber via the at least one input port; contacting the hydrocarbon feedstock with the microwave plasma in the reaction chamber; and producing hydrogen from the hydrocarbon feedstock.

In various embodiments, the present invention provides a method for microwave production of hydrogen from methane, comprising: providing a system for microwave production of hydrogen, the system comprising: a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the methane to the reaction chamber via the at least one input port; contacting the methane with the microwave plasma in the reaction chamber; and producing hydrogen from the methane.

In some embodiments, the at least one product is at least one reformed product. In some embodiments, the at least one product is at least one reformate. In some embodiments, the at least one reformed product is at least one reformate.

In some embodiments, the at least one product is at least one of hydrogen, carbon monoxide, carbon dioxide, aromatic hydrocarbons, or any combination thereof. In some embodiments, the at least one product is at least one of hydrogen, carbon monoxide, carbon dioxide, or any combination thereof. In some embodiments, the at least one product is at least hydrogen. In some embodiments, the at least one product is hydrogen.

In some embodiments, the microwave plasma is a microplasma.

In some embodiments, the hydrocarbon feedstock is methane or the hydrocarbon feedstock comprises methane.

In some embodiments, the hydrocarbon feedstock is natural gas or the hydrocarbon feedstock comprises natural gas.

In some embodiments, the hydrocarbon feedstock comprises methane, ethane, propane, isobutane, n-butane, n-pentane, isopentane, or tert-pentane, or any combination thereof. In some embodiments, the hydrocarbon feedstock comprises methane. In some embodiments, the hydrocarbon feedstock is methane. In some embodiments, the hydrocarbon feedstock is a gas. In some embodiments, the hydrocarbon feedstock is a liquid. In some embodiments, the hydrocarbon feedstock is a solid. In some embodiments, the hydrocarbon feedstock is a solid, liquid, gas, or any combination thereof. In some embodiments, the hydrocarbon feedstock is a liquid, gas, or a combination thereof.

In some embodiments, the natural gas comprises methane, ethane, propane, isobutane, n-butane, n-pentane, isopentane, or tert-pentane, or any combination thereof. In some embodiments, the natural gas comprises methane. In some embodiments, the natural gas is methane.

In some embodiments, the hydrocarbons are selected from the group consisting of methane, ethane, propane, isobutane, n-butane, n-pentane, isopentane, tert-pentane, and any combination thereof. In some embodiments, the hydrocarbons comprise methane. In some embodiments, the hydrocarbons are methane. In some embodiments, the hydrocarbons are gases. In some embodiments, the hydrocarbons are liquids. In some embodiments, the hydrocarbons are solids. In some embodiments, the hydrocarbons are solids, liquids, gases, or any combination thereof. In some embodiments, the hydrocarbons are liquids, gases, or a combination thereof.

In some embodiments, the at least one hydrocarbon is selected from the group consisting of methane, ethane, propane, isobutane, n-butane, n-pentane, isopentane, tert-pentane, and any combination thereof. In some embodiments, the at least one hydrocarbon comprises methane. In some embodiments, the at least one hydrocarbon is methane. In some embodiments, the at least one hydrocarbon is a gas. In some embodiments, the at least one hydrocarbon is a liquid. In some embodiments, the at least one hydrocarbon is a solid. In some embodiments, the at least one hydrocarbon is a solid, liquid, gas, or any combination thereof. In some embodiments, the at least one hydrocarbon is a liquid, gas, or a combination thereof.

In some embodiments, the hydrocarbon feedstock further comprises at least one selected from the group consisting of carbon dioxide and water, or a combination thereof.

In some embodiments, the natural gas further comprises at least one selected from the group consisting of carbon dioxide and water, or a combination thereof.

In some embodiments, the microwave reforming of hydrocarbons is microwave pyrolysis of hydrocarbons.

In some embodiments, the microwave reforming of hydrocarbons is microwave pyrolysis of natural gas.

In some embodiments, the microwave reforming of hydrocarbons is microwave pyrolysis of methane.

In some embodiments, the step of reforming the at least one hydrocarbon with the microwave plasma to produce hydrogen is reforming the at least one hydrocarbon with the microwave plasma to produce hydrogen and limit the amount of coke formed in the reaction chamber and/or system, and/or limit the amount of coke deposited in the reaction chamber and/or system.

In some embodiments, the method further comprises limiting the amount of coke formed, produced, and/or deposited in the reaction chamber and/or system.

Additional embodiments include those listed below:

In some embodiments, the microwave plasma is a thermal microwave plasma. In some embodiments, the microwave plasma is a non-thermal microwave plasma. In some embodiments, the microwave plasma is a thermal microwave plasma, a non-thermal microwave plasma, or both.

Additional embodiments include those listed below:

In various embodiments, the present invention provides a method for microwave pyrolysis of hydrocarbons, comprising: providing a system for microwave pyrolysis of hydrocarbons, the system comprising: a reaction chamber, wherein the reaction chamber comprises at least one input port and at least one outlet port; a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding a hydrocarbon feedstock to the reaction chamber via the at least one input port; contacting the hydrocarbon feedstock with the microwave plasma in the reaction chamber; and pyrolyzing the hydrocarbon feedstock with the microwave plasma to produce hydrogen.

In various embodiments, the present invention provides a method for microwave pyrolysis of at least one hydrocarbon, comprising: providing a system for microwave pyrolysis of at least one hydrocarbon, the system comprising: a reaction chamber, wherein the reaction chamber comprises at least one input port and at least one outlet port; a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding at least one hydrocarbon to the reaction chamber via the at least one input port; contacting the at least one hydrocarbon with the microwave plasma in the reaction chamber, and pyrolyzing the at least one hydrocarbon with the microwave plasma to produce hydrogen.

In various embodiments, the present invention provides a method for microwave pyrolysis of a hydrocarbon feedstock, comprising: providing a system for microwave pyrolysis of a hydrocarbon feedstock, the system comprising: a reaction chamber, wherein the reaction chamber comprises at least one input port and at least one outlet port; a reaction chamber, wherein the reaction chamber comprises at least one input port and at least one outlet port; a three-dimensional catalyst material positioned in the reaction chamber; and a magnetron for generating microwave energy, wherein the magnetron is in communication with the reaction chamber; contacting the three-dimensional catalyst material with microwave energy to generate a microwave plasma in the reaction chamber; adding the hydrocarbon feedstock to the reaction chamber via the at least one input port, contacting the hydrocarbon feedstock with the microwave plasma in the reaction chamber; and pyrolyzing the hydrocarbon feedstock with the microwave plasma to produce hydrogen.

In various embodiments, the present invention provides a method for microwave pyrolysis of natural gas, comprising: providing a system for microwave pyrolysis of natural gas, the system comprising: a reaction chamber, wherein the reaction chamber comprises at least one input port and at least one outlet port; a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the natural gas to the reaction chamber via the at least one input port; contacting the natural gas with the microwave plasma in the reaction chamber; and pyrolyzing the natural gas with the microwave plasma to produce hydrogen.

In various embodiments, the present invention provides a method for microwave pyrolysis of methane, comprising: providing a system for microwave pyrolysis of the methane, the system comprising: a reaction chamber, wherein the reaction chamber comprises at least one input port and at least one outlet port; a reaction chamber, wherein the reaction chamber comprises at least one input port and at least one outlet port; a three-dimensional catalyst material positioned in the reaction chamber, and a magnetron for generating microwave energy, wherein the magnetron is in communication with the reaction chamber; contacting the three-dimensional catalyst material with microwave energy to generate a microwave plasma in the reaction chamber; adding the methane to the reaction chamber via the at least one input port; contacting the methane with the microwave plasma in the reaction chamber; and pyrolyzing the methane with the microwave plasma to produce hydrogen.

In some embodiments, the microwave plasma is a microplasma.

In some embodiments, the hydrocarbon feedstock is methane or the hydrocarbon feed stock comprises methane.

In some embodiments, the hydrocarbon feedstock is natural gas or the hydrocarbon feedstock comprises natural gas.

In some embodiments, the hydrocarbon feedstock comprises methane, ethane, propane, isobutane, n-butane, n-pentane, isopentane, or tert-pentane, or any combination thereof. In some embodiments, the hydrocarbon feedstock comprises methane. In some embodiments, the hydrocarbon feedstock is methane. In some embodiments, the hydrocarbon feedstock is a gas. In some embodiments, the hydrocarbon feedstock is a liquid. In some embodiments, the hydrocarbon feedstock is a solid. In some embodiments, the hydrocarbon feedstock is a solid, liquid, gas, or any combination thereof. In some embodiments, the hydrocarbon feedstock is a liquid, gas, or a combination thereof.

In some embodiments, the natural gas comprises methane, ethane, propane, isobutane, n-butane, n-pentane, isopentane, or tert-pentane, or any combination thereof. In some embodiments, the natural gas comprises methane. In some embodiments, the natural gas is methane.

In some embodiments, the hydrocarbons are selected from the group consisting of methane, ethane, propane, isobutane, n-butane, n-pentane, isopentane, tert-pentane, and any combination thereof. In some embodiments, the hydrocarbons comprise methane. In some embodiments, the hydrocarbons are methane. In some embodiments, the hydrocarbons are gases. In some embodiments, the hydrocarbons are liquids. In some embodiments, the hydrocarbons are solids. In some embodiments, the hydrocarbons are solids, liquids, gases, or any combination thereof. In some embodiments, the hydrocarbons are liquids, gases, or a combination thereof.

In some embodiments, the at least one hydrocarbon is selected from the group consisting of methane, ethane, propane, isobutane, n-butane, n-pentane, isopentane, tert-pentane, and any combination thereof. In some embodiments, the at least one hydrocarbon comprises methane. In some embodiments, the at least one hydrocarbon is methane. In some embodiments, the at least one hydrocarbon is a gas. In some embodiments, the at least one hydrocarbon is a liquid. In some embodiments, the at least one hydrocarbon is a solid. In some embodiments, the at least one hydrocarbon is a solid, liquid, gas, or any combination thereof. In some embodiments, the at least one hydrocarbon is a liquid, gas, or a combination thereof.

In some embodiments, the hydrocarbon feedstock further comprises at least one selected from the group consisting of carbon dioxide and water, or a combination thereof.

In some embodiments, the natural gas further comprises at least one selected from the group consisting of carbon dioxide and water, or a combination thereof.

In some embodiments, the microwave pyrolysis of hydrocarbons is microwave pyrolysis of natural gas.

In some embodiments, the microwave pyrolysis of hydrocarbons is microwave pyrolysis of methane.

In some embodiments, the step of reforming the at least one hydrocarbon with the microwave plasma to produce hydrogen is reforming the at least one hydrocarbon with the microwave plasma to produce hydrogen and limit the amount of coke formed in the reaction chamber and/or system, and/or limit the amount of coke deposited in the reaction chamber and/or system.

In some embodiments, the method further comprises limiting the amount of coke formed, produced, and/or deposited in the reaction chamber and/or system.

Additional embodiments include those listed below:

In various embodiments, the present invention provides a method for microwave reforming of hydrocarbons, comprising: providing a catalyst for microwave reforming of hydrocarbons, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting a hydrocarbon feedstock with the microwave plasma; and reforming the hydrocarbon feedstock with the microwave plasma to produce hydrogen.

In various embodiments, the present invention provides a method for microwave reforming of hydrocarbons, comprising: providing a catalyst for microwave reforming of hydrocarbons, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting a hydrocarbon feedstock with the microwave plasma; and reforming the hydrocarbon feedstock with the microwave plasma to produce hydrogen.

In various embodiments, the present invention provides a method for microwave reforming of hydrocarbons, comprising: providing a catalyst for microwave reforming of hydrocarbons, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting a hydrocarbon feedstock with the microwave plasma; and reforming the hydrocarbon feedstock with the microwave plasma to produce at least one product.

In various embodiments, the present invention provides a method for microwave reforming of hydrocarbons, comprising: providing a catalyst for microwave reforming of hydrocarbons, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting a hydrocarbon feedstock with the microwave plasma; and reforming the hydrocarbon feedstock with the microwave plasma to produce at least one product.

In various embodiments, the present invention provides a method for microwave production of hydrogen from hydrocarbons, comprising: providing a catalyst for microwave production of hydrogen, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting a hydrocarbon feedstock with the microwave plasma; and producing hydrogen from the hydrocarbon feedstock.

In various embodiments, the present invention provides a method for microwave production of hydrogen from hydrocarbons, comprising: providing a catalyst for microwave production of hydrogen, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting a hydrocarbon feedstock with the microwave plasma; and producing hydrogen from the hydrocarbon feedstock.

In various embodiments, the present invention provides a method for microwave reforming of at least one hydrocarbon, comprising: providing a catalyst for microwave reforming of the at least one hydrocarbon, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the at least one hydrocarbon with the microwave plasma; and reforming the at least one hydrocarbon with the microwave plasma to produce hydrogen.

In various embodiments, the present invention provides a method for microwave reforming of at least one hydrocarbon, comprising: providing a catalyst for microwave reforming of the at least one hydrocarbon, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the at least one hydrocarbon with the microwave plasma; and reforming the at least one hydrocarbon with the microwave plasma to produce hydrogen.

In various embodiments, the present invention provides a method for microwave reforming of at least one hydrocarbon, comprising: providing a catalyst for microwave reforming of the at least one hydrocarbon, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the at least one hydrocarbon with the microwave plasma; and reforming the at least one hydrocarbon with the microwave plasma to produce at least one product.

In various embodiments, the present invention provides a method for microwave reforming of at least one hydrocarbon, comprising: providing a catalyst for microwave reforming of the at least one hydrocarbon, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the at least one hydrocarbon with the microwave plasma; and reforming the at least one hydrocarbon with the microwave plasma to produce at least one product.

In various embodiments, the present invention provides a method for microwave production of hydrogen from at least one hydrocarbon, comprising: providing a catalyst for microwave production of hydrogen, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the at least one hydrocarbon with the microwave plasma; and producing hydrogen from the at least one hydrocarbon.

In various embodiments, the present invention provides a method for microwave reforming of at least one hydrocarbon, comprising: providing a catalyst for microwave reforming of the at least one hydrocarbon, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the at least one hydrocarbon with the microwave plasma; and reforming the at least one hydrocarbon with the microwave plasma to produce at least one product.

In various embodiments, the present invention provides a method for microwave reforming of a hydrocarbon feedstock, comprising: providing a catalyst for microwave reforming of the hydrocarbon feedstock, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the hydrocarbon feedstock with the microwave plasma; and reforming the hydrocarbon feedstock with the microwave plasma to produce hydrogen.

In various embodiments, the present invention provides a method for microwave reforming of a hydrocarbon feedstock, comprising: providing a catalyst for microwave reforming of the hydrocarbon feedstock, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the hydrocarbon feedstock with the microwave plasma; and reforming the hydrocarbon feedstock with the microwave plasma to produce hydrogen.

In various embodiments, the present invention provides a method for microwave reforming of a hydrocarbon feedstock, comprising: providing a catalyst for microwave reforming of the hydrocarbon feedstock, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the hydrocarbon feedstock with the microwave plasma; and reforming the hydrocarbon feedstock with the microwave plasma to produce at least one product.

In various embodiments, the present invention provides a method for microwave reforming of a hydrocarbon feedstock, comprising: providing a catalyst for microwave reforming of the hydrocarbon feedstock, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the hydrocarbon feedstock with the microwave plasma; and reforming the hydrocarbon feedstock with the microwave plasma to produce at least one product.

In various embodiments, the present invention provides a method for microwave production of hydrogen from a hydrocarbon feedstock, comprising: providing a catalyst for microwave production of hydrogen from the hydrocarbon feedstock, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the hydrocarbon feedstock with the microwave plasma; and producing hydrogen from the hydrocarbon feedstock.

In various embodiments, the present invention provides a method for microwave production of hydrogen from a hydrocarbon feedstock, comprising: providing a catalyst for microwave production of hydrogen from the hydrocarbon feedstock, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the hydrocarbon feedstock with the microwave plasma; and producing hydrogen from the hydrocarbon feedstock.

In some embodiments, the at least one product is at least one reformed product. In some embodiments, the at least one product is at least one reformate. In some embodiments, the at least one reformed product is at least one reformate.

In some embodiments, the at least one product is at least one of hydrogen, carbon monoxide, carbon dioxide, aromatic hydrocarbons, or any combination thereof. In some embodiments, the at least one product is at least one of hydrogen, carbon monoxide, carbon dioxide, or any combination thereof. In some embodiments, the at least one product is at least hydrogen. In some embodiments, the at least one product is hydrogen.

In some embodiments, the microwave plasma is a microplasma.

In some embodiments, the hydrocarbon feedstock is methane or the hydrocarbon feedstock comprises methane.

In some embodiments, the hydrocarbon feedstock is natural gas or the hydrocarbon feedstock comprises natural gas.

In some embodiments, the hydrocarbon feedstock comprises methane, ethane, propane, isobutane, n-butane, n-pentane, isopentane, or tert-pentane, or any combination thereof. In some embodiments, the hydrocarbon feedstock comprises methane. In some embodiments, the hydrocarbon feedstock is methane. In some embodiments, the hydrocarbon feedstock is a gas. In some embodiments, the hydrocarbon feedstock is a liquid. In some embodiments, the hydrocarbon feedstock is a solid. In some embodiments, the hydrocarbon feedstock is a solid, liquid, gas, or any combination thereof. In some embodiments, the hydrocarbon feedstock is a liquid, gas, or a combination thereof.

In some embodiments, the natural gas comprises methane, ethane, propane, isobutane, n-butane, n-pentane, isopentane, or tert-pentane, or any combination thereof. In some embodiments, the natural gas comprises methane. In some embodiments, the natural gas is methane.

In some embodiments, the hydrocarbons are selected from the group consisting of methane, ethane, propane, isobutane, n-butane, n-pentane, isopentane, tert-pentane, and any combination thereof. In some embodiments, the hydrocarbons comprise methane. In some embodiments, the hydrocarbons are methane. In some embodiments, the hydrocarbons are gases. In some embodiments, the hydrocarbons are liquids. In some embodiments, the hydrocarbons are solids. In some embodiments, the hydrocarbons are solids, liquids, gases, or any combination thereof. In some embodiments, the hydrocarbons are liquids, gases, or a combination thereof.

In some embodiments, the at least one hydrocarbon is selected from the group consisting of methane, ethane, propane, isobutane, n-butane, n-pentane, isopentane, tert-pentane, and any combination thereof. In some embodiments, the at least one hydrocarbon comprises methane. In some embodiments, the at least one hydrocarbon is methane. In some embodiments, the at least one hydrocarbon is a gas. In some embodiments, the at least one hydrocarbon is a liquid. In some embodiments, the at least one hydrocarbon is a solid. In some embodiments, the at least one hydrocarbon is a solid, liquid, gas, or any combination thereof. In some embodiments, the at least one hydrocarbon is a liquid, gas, or a combination thereof.

In some embodiments, the hydrocarbon feedstock further comprises at least one selected from the group consisting of carbon dioxide and water, or a combination thereof.

In some embodiments, the natural gas further comprises at least one selected from the group consisting of carbon dioxide and water, or a combination thereof.

In some embodiments, the microwave reforming of hydrocarbons is microwave pyrolysis of hydrocarbons.

In some embodiments, the microwave reforming of hydrocarbons is microwave pyrolysis of natural gas.

In some embodiments, wherein the microwave reforming of hydrocarbons is microwave pyrolysis of methane.

In some embodiments, the catalyst body is porous.

In some embodiments, catalyst body comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the catalyst body is carbon fiber or comprises carbon fiber. In some embodiments, the catalyst body comprises carbon foam. In some embodiments, the catalyst body is carbon foam.

In some embodiments, the metal-based material comprises at least one of aluminum, stainless steel, maraging steel, nickel alloy, titanium, aluminum alloy, cobalt alloy, or titanium alloy.

In some embodiments, the step of reforming the at least one hydrocarbon with the microwave plasma to produce hydrogen is reforming the at least one hydrocarbon with the microwave plasma to produce hydrogen and limit the amount of coke formed in the reaction chamber and/or system, and/or limit the amount of coke deposited in the reaction chamber and/or system.

In some embodiments, the method further comprises limiting the amount of coke formed, produced, and/or deposited in the reaction chamber and/or system.

Additional embodiments include those listed below:

In various embodiments, the present invention provides a method for microwave pyrolysis of hydrocarbons, comprising: providing a catalyst for microwave pyrolysis of hydrocarbons, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting a hydrocarbon feedstock with the microwave plasma; and pyrolyzing the hydrocarbon feedstock with the microwave plasma to produce hydrogen.

In various embodiments, the present invention provides a method for microwave pyrolysis of hydrocarbons, comprising: providing a catalyst for microwave pyrolysis of hydrocarbons, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting a hydrocarbon feedstock with the microwave plasma; and pyrolyzing the hydrocarbon feedstock with the microwave plasma to produce hydrogen.

In various embodiments, the present invention provides a method for microwave pyrolysis of at least one hydrocarbon, comprising: providing a catalyst for microwave pyrolysis of at least one hydrocarbon, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the at least one hydrocarbon with the microwave plasma; and pyrolyzing the at least one hydrocarbon with the microwave plasma to produce hydrogen.

In various embodiments, the present invention provides a method for microwave pyrolysis of at least one hydrocarbon, comprising: providing a catalyst for microwave pyrolysis of at least one hydrocarbon, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the at least one hydrocarbon with the microwave plasma; and pyrolyzing the at least one hydrocarbon with the microwave plasma to produce hydrogen.

In various embodiments, the present invention provides a method for microwave pyrolysis of a hydrocarbon feedstock, comprising: providing a catalyst for microwave pyrolysis of the hydrocarbon feedstock, the catalyst comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy; contacting the catalyst with microwave energy to generate a microwave plasma; contacting the hydrocarbon feedstock with the microwave plasma; and pyrolyzing the hydrocarbon feedstock with the microwave plasma to produce hydrogen.

In various embodiments, the present invention provides a method for microwave pyrolysis of a hydrocarbon feedstock, comprising: providing a catalyst for microwave pyrolysis of the hydrocarbon feedstock, the catalyst comprising: a catalyst body comprising a catalyst material, wherein the catalyst body has a three-dimensional structure, and wherein the three-dimensional structure is configured to form a thermal hot spot within the catalyst body or on a surface of the catalyst body when subjected to microwave energy; contacting the catalyst with microwave energy to generate a microwave plasma; contacting the hydrocarbon feedstock with the microwave plasma, and pyrolyzing the hydrocarbon feedstock with the microwave plasma to produce hydrogen.

In some embodiments, the microwave plasma is a microplasma.

In some embodiments, the hydrocarbon feedstock is methane or the hydrocarbon feedstock comprises methane.

In some embodiments, the hydrocarbon feedstock is natural gas or the hydrocarbon feedstock comprises natural gas.

In some embodiments, the hydrocarbon feedstock comprises methane, ethane, propane, isobutane, n-butane, n-pentane, isopentane, or tert-pentane, or any combination thereof. In some embodiments, the hydrocarbon feedstock is methane. In some embodiments, the hydrocarbon feedstock comprises methane. In some embodiments, the hydrocarbon feedstock is a gas. In some embodiments, the hydrocarbon feedstock is a liquid. In some embodiments, the hydrocarbon feedstock is a solid. In some embodiments, the hydrocarbon feedstock is a solid, liquid, gas, or any combination thereof. In some embodiments, the hydrocarbon feedstock is a liquid, gas, or a combination thereof.

In some embodiments, the natural gas comprises methane, ethane, propane, isobutane, n-butane, n-pentane, isopentane, or tert-pentane, or any combination thereof. In some embodiments, the natural gas comprises methane. In some embodiments, the natural gas is methane.

In some embodiments, the hydrocarbons are selected from the group consisting of methane, ethane, propane, isobutane, n-butane, n-pentane, isopentane, tert-pentane, and any combination thereof. In some embodiments, the hydrocarbon is methane. In some embodiments, the hydrocarbons comprise methane. In some embodiments, the hydrocarbons are gases. In some embodiments, the hydrocarbons are liquids. In some embodiments, the hydrocarbons are solids. In some embodiments, the hydrocarbons are solids, liquids, gases, or any combination thereof. In some embodiments, the hydrocarbons are liquids, gases, or a combination thereof.

In some embodiments, the at least one hydrocarbon is selected from the group consisting of methane, ethane, propane, isobutane, n-butane, n-pentane, isopentane, tert-pentane, and any combination thereof. In some embodiments, the at least one hydrocarbon is methane. In some embodiments, the at least one hydrocarbon comprises methane. In some embodiments, the at least one hydrocarbon is a gas. In some embodiments, the at least one hydrocarbon is a liquid. In some embodiments, the at least one hydrocarbon is a solid. In some embodiments, the at least one hydrocarbon is a solid, liquid, gas, or any combination thereof. In some embodiments, the at least one hydrocarbon is a liquid, gas, or a combination thereof.

In some embodiments, the hydrocarbon feedstock further comprises at least one selected from the group consisting of carbon dioxide and water, or a combination thereof.

In some embodiments, the natural gas further comprises at least one selected from the group consisting of carbon dioxide and water, or a combination thereof.

In some embodiments, the microwave pyrolysis of hydrocarbons is microwave pyrolysis of natural gas.

In some embodiments, the microwave pyrolysis of hydrocarbons is microwave pyrolysis of methane.

In some embodiments, the catalyst body is porous.

In some embodiments, catalyst body comprises a carbon-based material, a metal-based material, or combination thereof.

In some embodiments, the carbon-based material comprises at least one of carbon foam, carbon fiber, active carbon, carbon black, charcoal, coal, biomass-derived carbon, or any combination thereof. In some embodiments, the carbon-based material comprises carbon fiber. In some embodiments, the carbon-based material is carbon fiber.

In some embodiments, the catalyst body is carbon fiber or comprises carbon fiber. In some embodiments, the catalyst body comprises carbon foam. In some embodiments, the catalyst body is carbon foam.

In some embodiments, the metal-based material comprises at least one of aluminum, stainless steel, maraging steel, nickel alloy, titanium, aluminum alloy, cobalt alloy, or titanium alloy.

In some embodiments, the step of reforming the at least one hydrocarbon with the microwave plasma to produce hydrogen is reforming the at least one hydrocarbon with the microwave plasma to produce hydrogen and limit the amount of coke formed in the reaction chamber and/or system, and/or limit the amount of coke deposited in the reaction chamber and/or system.

In some embodiments, the method further comprises limiting the amount of coke formed, produced, and/or deposited in the reaction chamber and/or system.

Additional embodiments include those listed below:

In some embodiments, the reforming of hydrocarbons is steam reforming of hydrocarbons, dry reforming of hydrocarbons, partial oxidation of hydrocarbons, or thermal decomposition of hydrocarbons. In some embodiments, the reforming of hydrocarbons is pyrolysis of hydrocarbons. In some embodiments, thermal decomposition of hydrocarbons is pyrolysis of hydrocarbons.

In some embodiments, the reforming of hydrocarbons is steam reforming of at least one hydrocarbon, dry reforming of at least one hydrocarbon, partial oxidation of at least one hydrocarbon, or thermal decomposition of at least one hydrocarbon. In some embodiments, the reforming of hydrocarbons is pyrolysis of at least one hydrocarbon. In some embodiments, thermal decomposition of at least one hydrocarbon is pyrolysis of at least one hydrocarbon.

In some embodiments, the reforming of hydrocarbons is steam reforming of methane, dry reforming of methane, partial oxidation of methane, or thermal decomposition of methane. In some embodiments, the reforming of hydrocarbons is pyrolysis of methane. In some embodiments, thermal decomposition of methane is pyrolysis of methane.

In some embodiments, the reforming of hydrocarbons is steam reforming of natural gas, dry reforming of natural gas, partial oxidation of natural gas, or thermal decomposition of natural gas. In some embodiments, the reforming of hydrocarbons is pyrolysis of natural gas. In some embodiments, thermal decomposition of natural gas is pyrolysis of natural gas.

In some embodiments, the reforming of hydrocarbons is steam reforming of a hydrocarbon feedstock, dry reforming of a hydrocarbon feedstock partial oxidation of a hydrocarbon stock, or thermal decomposition of a hydrocarbon feedstock. In some embodiments, the reforming of hydrocarbons is pyrolysis of a hydrocarbon feedstock. In some embodiments, thermal decomposition of hydrocarbons is pyrolysis of a hydrocarbon feedstock.

In some embodiments, the reforming of a hydrocarbon feedstock is steam reforming of a hydrocarbon feedstock, dry reforming of a hydrocarbon feedstock, partial oxidation of a hydrocarbon feedstock, or thermal decomposition of a hydrocarbon feedstock. In some embodiments, the reforming of hydrocarbons is pyrolysis of a hydrocarbon feedstock. In some embodiments, thermal decomposition of a hydrocarbon feedstock is pyrolysis of a hydrocarbon feedstock.

In some embodiments, the reforming of at least one hydrocarbon is steam reforming of at least one hydrocarbon, dry reforming of at least one hydrocarbon, partial oxidation of at least one hydrocarbon, or thermal decomposition of at least one hydrocarbon. In some embodiments, the reforming of at least one hydrocarbon is pyrolysis of at least one hydrocarbon. In some embodiments, thermal decomposition of at least one hydrocarbon is pyrolysis of at least one hydrocarbon.

In some embodiments, the reforming of methane is steam reforming of methane, dry reforming of methane, partial oxidation of methane, or thermal decomposition of methane. In some embodiments, the reforming of methane is pyrolysis of methane. In some embodiments, thermal decomposition of methane is pyrolysis of methane.

In some embodiments, the reforming of natural gas is steam reforming of natural gas, dry reforming of natural gas, partial oxidation of natural gas, or thermal decomposition of natural gas. In some embodiments, the reforming of natural gas is pyrolysis of natural gas. In some embodiments, thermal decomposition of natural gas is pyrolysis of natural gas.

In some embodiments, a plasma hot spot is a thermal hot spot.

In some embodiments, the point, area, region, and/or part of an object can be any point, area, region, and/or part of the object. Non-limiting examples of an object include a catalyst, a catalyst body, a catalyst material, a three-dimensional support, a surface of a catalyst, a surface of a catalyst body, a surface of a catalyst material, or a surface of a three-dimensional support.

In some embodiments, the thermal hot spot is positioned or located at a point, area, region, and/or part along any dimension of an object. Non-limiting examples of dimensions include length, width, height, depth, diameter, base, and/or radius. In some embodiments, the thermal hot spot is positioned or located at a point, area, region, and/or part along any length, width, height, depth, diameter, base, and/or radius of an object. Non-limiting examples of an object include a catalyst, a catalyst body, a catalyst material, a three-dimensional support, a surface of a catalyst, a surface of a catalyst body, a surface of a catalyst material, or a surface of a three-dimensional support.

In some embodiments, the localized thermal hot spot is positioned, located, or localized at a point, area, region, and/or part along any dimension of an object. Non-limiting examples of dimensions include length, width, height, depth, diameter, base, and/or radius. In some embodiments, the localized thermal hot spot is positioned, located, or localized at a point, area, region, and/or part along any length, width, height, depth, diameter, base, and/or radius of an object. Non-limiting examples of an object include a catalyst, a catalyst body, a catalyst material, a three-dimensional support, a surface of a catalyst, a surface of a catalyst body, a surface of a catalyst material, or a surface of a three-dimensional support.

In some embodiments, there are no limitations on the number of thermal hot spots. In some embodiments, the thermal hot spot is at least one thermal hot spot. In some embodiments, the thermal hot spot is at least two thermal hot spots. In some embodiments, the thermal hot spot is at least three thermal hot spots. In some embodiments, the number of thermal hot spots is 1-20 thermal hot spots and any number of thermal hot spots in this range. In some embodiments, the number of thermal hot spots is 1, 2, 3, 4, 5, 6, 7, 8, 9, 10, 11, 12, 13, 14, 15, 16, 17, 18, 19, or 20 thermal hot spots.

In some embodiments, there are no limitations on the number of localized thermal hot spots. In some embodiments, the localized thermal hot spot is at least one localized thermal hot spot. In some embodiments, the localized thermal hot spot is at least two localized thermal hot spots. In some embodiments, the localized thermal hot spot is at least three localized thermal hot spots. In some embodiments, the number of localized thermal hot spots is 1-20 localized thermal hot spots and any number of localized thermal hot spots in this range. In some embodiments, the number of localized thermal hot spots is 1, 2, 3, 4, 5, 6, 7, 8, 9, 10, 11, 12, 13, 14, 15, 16, 17, 18, 19, or 20 localized thermal hot spots.

Additional embodiments include those listed below:
Embodiment 79. A catalyst for microwave reforming of hydrocarbons, comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy.
Embodiment 80. The catalyst of embodiment 79, wherein the three-dimensional structure comprises any geometry.
Embodiment 81. The catalyst of embodiment 79, wherein the three-dimensional structure is configured to maximize the temperature of the localized thermal hot spot.
Embodiment 82. The catalyst of embodiment 79, wherein the three-dimensional structure is configured to form a microwave plasma when subjected to microwave energy.
Embodiment 83. The catalyst of embodiment 79, wherein the catalyst body is porous.
Embodiment 84. The catalyst of embodiment 79, wherein the catalyst body comprises a carbon-based material, a metal-based material, or combination thereof.
Embodiment 85. The catalyst of embodiment 84, wherein the carbon-based material comprises at least one of carbon foam, carbon fiber, active carbon, carbon black, charcoal, coal, biomass-derived carbon, or any combination thereof.
Embodiment 86. The catalyst of embodiment 84, wherein the metal-based material comprises at least one of aluminum, stainless steel, maraging steel, nickel alloy, titanium, aluminum alloy, cobalt alloy, or titanium alloy.
Embodiment 87. The catalyst of embodiment 79, wherein the catalyst material is a carbon-based catalyst material, a metal-based catalyst material, or a combination thereof.
Embodiment 88. The catalyst of embodiment 87, wherein the carbon-based material is selected from the group consisting of carbon foam, carbon fiber, active carbon, carbon black, charcoal, coal, biomass-derived carbon, and any combination thereof.
Embodiment 89. The catalyst of embodiment 87, wherein the metal-based catalyst material comprises at least one transition metal.
Embodiment 90. The catalyst of embodiment 89, wherein the at least one transition metal is selected from the group consisting of nickel, cobalt, iron, copper, molybdenum, ruthenium, platinum, and any combination thereof.
Embodiment 91. A system for microwave reforming of hydrocarbons, comprising: a reaction chamber, wherein the reaction chamber comprises at least one input port and at least one outlet port; a catalyst of embodiment 79 positioned in the reaction chamber; and a magnetron for generating microwave energy, wherein the magnetron is in communication with the reaction chamber.
Embodiment 92. The system of embodiment 91, further comprising a carbon separator in communication with the at least one outlet port.
Embodiment 93. The system of embodiment 91, further comprising a hydrogen separator, wherein the hydrogen separator is in communication with the at least one outlet port.
Embodiment 94. A method for microwave reforming of hydrocarbons, comprising: providing a system of embodiment 91, contacting the catalyst with microwave energy to generate a microwave plasma in the reaction chamber; adding a hydrocarbon feedstock to the reaction chamber via the at least one input port; contacting the hydrocarbon feedstock with the microwave plasma in the reaction chamber; and reforming the hydrocarbon feedstock with the microwave plasma to produce hydrogen.
Embodiment 95. The method of embodiment 94, wherein the hydrocarbon feedstock comprises natural gas.
Embodiment 96. A method for microwave reforming of hydrocarbons, comprising: providing a catalyst of embodiment 79; contacting the catalyst with microwave energy to generate a microwave plasma; contacting a hydrocarbon feedstock with the microwave plasma; and reforming the hydrocarbon feedstock with the microwave plasma to produce hydrogen.
Embodiment 97. The method of embodiment 96, wherein the hydrocarbon feedstock comprises natural gas.
Embodiment 98. Use of a catalyst of embodiment 79 for microwave reforming at least one hydrocarbon.

Additional embodiments include those listed below;
Embodiment 99. A catalyst for microwave reforming of hydrocarbons, comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy
Embodiment 100. The catalyst of embodiment 99, wherein the three-dimensional structure comprises any geometry.
Embodiment 101. The catalyst of embodiment 99, wherein the three-dimensional structure is configured to maximize the temperature of the localized thermal hot spot.
Embodiment 102. The catalyst of embodiment 99, wherein the three-dimensional structure is configured to form a microwave plasma when subjected to microwave energy.
Embodiment 103. The catalyst of embodiment 102, wherein the catalyst body comprises a carbon-based material, a metal-based material, or combination thereof.
Embodiment 104. The catalyst of embodiment 103, wherein the carbon-based material comprises at least one of carbon foam, carbon fiber, active carbon, carbon black, charcoal, coal, biomass-derived carbon, or any combination thereof.
Embodiment 105. The catalyst of embodiment 103, wherein the metal-based material comprises at least one of aluminum, stainless steel, maraging steel, nickel alloy, titanium, aluminum alloy, cobalt alloy, or titanium alloy.
Embodiment 106. The catalyst of embodiment 99, wherein the catalyst material is a carbon-based catalyst material, a metal-based catalyst material, or a combination thereof.
Embodiment 107. The catalyst of embodiment 106, wherein the carbon-based catalyst material comprises at least one of carbon foam, carbon fiber, active carbon, carbon black, charcoal, coal, biomass-derived carbon, or any combination thereof.
Embodiment 108. The catalyst of embodiment 106, wherein the metal-based catalyst material comprises at least one transition metal.
Embodiment 109. A system for microwave reforming of hydrocarbons, comprising: a reaction chamber, wherein the reaction chamber comprises at least one input port and at least one outlet port; a catalyst of embodiment 99, positioned in the reaction chamber; and a magnetron for generating microwave energy, wherein the magnetron is in communication with the reaction chamber.
Embodiment 110. The system of embodiment 109, further comprising a hydrogen separator, wherein the hydrogen separator is in communication with the at least one outlet port.
Embodiment 111. A method for microwave reforming of hydrocarbons, comprising: providing a system of embodiment 109; contacting the catalyst with microwave energy to generate a microwave plasma in the reaction chamber; adding a hydrocarbon feedstock to the reaction chamber via the at least one input port; contacting the hydrocarbon feedstock with the microwave plasma in the reaction chamber, and reforming the hydrocarbon feedstock with the microwave plasma to produce hydrogen.
Embodiment 112. A method for microwave reforming of hydrocarbons, comprising: providing a catalyst of embodiment 99; contacting the catalyst with microwave energy to generate a microwave plasma; contacting a hydrocarbon feedstock with the microwave plasma; and reforming the hydrocarbon feedstock with the microwave plasma to produce hydrogen.
Embodiment 113. Use of a catalyst of embodiment 99 for microwave reforming at least one hydrocarbon.

### EXAMPLES

The invention is further illustrated by the following examples which are intended to be purely exemplary of the invention, and which should not be construed as limiting the invention in any way. The following examples are illustrative only, and are not intended to limit, in any manner, any of the aspects described herein. The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Experiments

### Materials and Methods

### Example 1

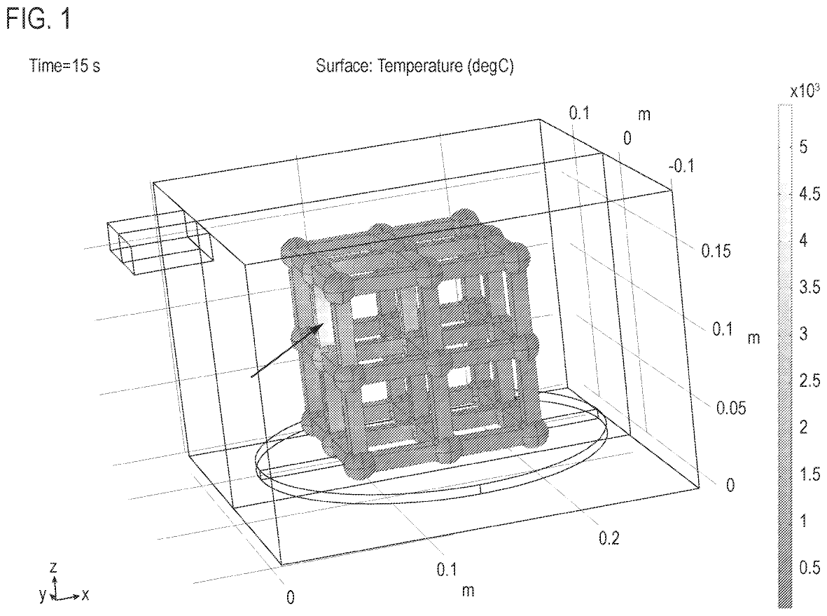

FIG. 1 depicts a catalyst for microwave reforming of hydrocarbons showing the formation of a localized thermal hot spot within the three-dimensional catalyst material or on a surface of the three-dimensional catalyst material. The position and/or area of the localized thermal hot spot (e.g., localized heating) is indicated by the arrow. The catalyst shown in FIG. 1 was designed and studied using COMSOL Multiphysics® software. The catalyst shown in FIG. 1 was subjected to simulated microwave heating in the reactor shown in FIG. 12 for 15 seconds.

### Example 2

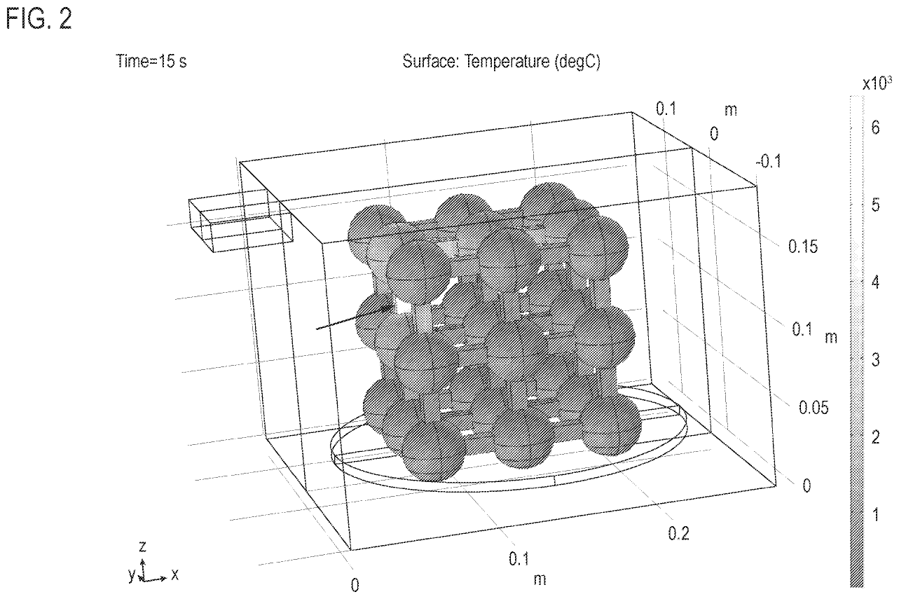

FIG. 2 depicts a catalyst for microwave reforming of hydrocarbons showing the formation of a localized thermal hot spot within the three-dimensional catalyst material or on a surface of the three-dimensional catalyst material. The position and/or area of the localized thermal hot spot (e.g., localized heating) is indicated by the arrow. The catalyst shown in FIG. 2 was designed and studied using COMSOL Multiphysics® software. The catalyst shown in FIG. 2 was subjected to simulated microwave heating in the reactor shown in FIG. 12 for 15 seconds.

### Example 3

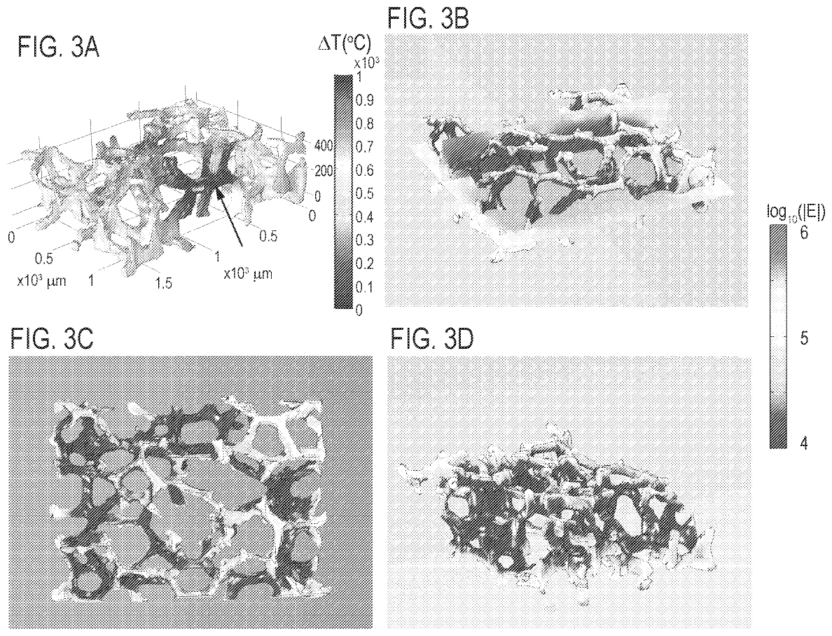

FIG. 3A-FIG. 3D depicts electric field and temperature distribution on a three-dimensional carbon foam showing localized heating (e.g., localized thermal hot spot formation). FIG. 3A depicts in accordance with various embodiments of the invention, temperature distribution on a three-dimensional carbon foam after five seconds of microwave heating. In FIG. 3A the position and/or area of the localized thermal hot spot (e.g., localized heating) is indicated by the arrow. FIG. 3B depicts in accordance with various embodiments of the invention, the electric field distribution around the three-dimensional carbon foam. FIG. 3C-FIG. 3D depicts in accordance with various embodiments of the invention, electric field distribution on the three-dimensional carbon foam at different angles. FIG. 3A-FIG. 3D and the three-dimensional carbon foam were designed and studied using COMSOL Multiphysics® software.

### Example 4

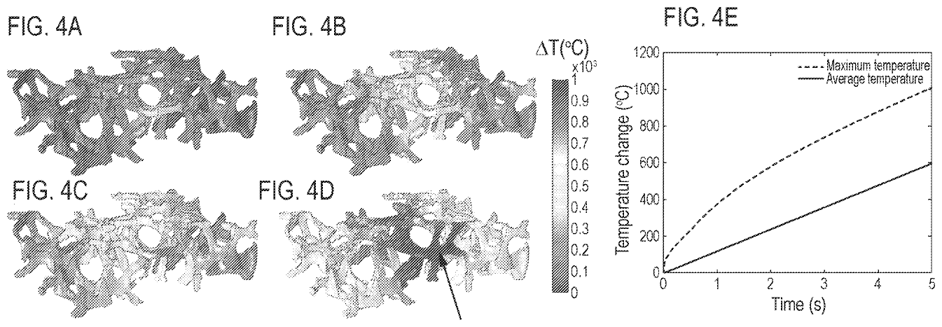

FIG. 4A-FIG. 4E depicts temperature distribution changes over time on three-dimensional carbon foam, where the heating time is 1 second (FIG. 4A), 2 seconds (FIG. 4B), 3 seconds (FIG. 4C), and 5 seconds (FIG. 4D). FIG. 4E depicts in accordance with various embodiments of the invention a temperature vs. time curve showing that the temperature quickly increases to 1000° C. in 5 seconds for the three-dimension carbon foam structure. FIG. 4A-FIG. 4D show that the temperature distribution on the three-dimensional carbon foam is not uniform. The temperature distribution is localized to a specific area/region within the three-dimensional catalyst material or on a specific surface of the three-dimensional catalyst material thereby forming a localized thermal hot spot within the three-dimensional catalyst material or on a surface of the three-dimensional catalyst material. In FIG. 4D the position and/or area of the localized thermal hot spot (e.g., localized heating) is indicated by the arrow. FIG. 4A-FIG. 4E and the three-dimensional carbon foam were designed and studied using COMSOL Multiphysics® software.

### Example 5

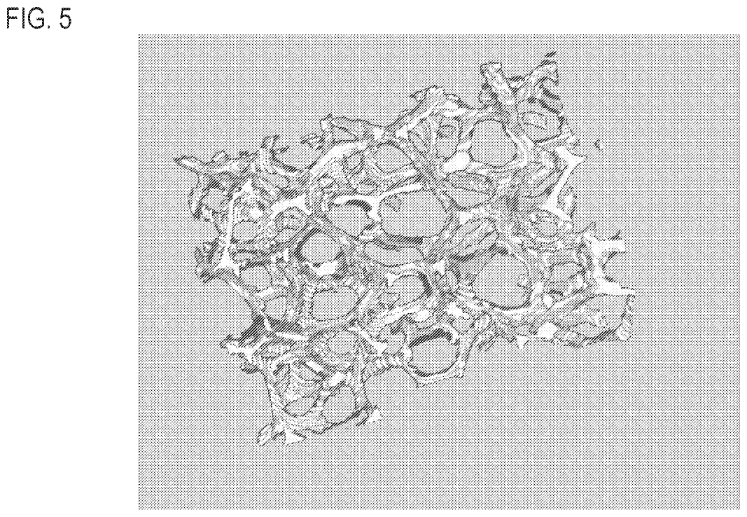

FIG. 5 depicts an example of a three-dimensional catalyst support. Without being limited by theory, the structure/geometry of the three-dimensional catalyst support will (i) enable and enhance the formation of the localized microwave plasma; (ii) allow gases to flow through the catalyst support; and (iii) aid in the removal of carbon produced during hydrocarbon reforming and/or hydrocarbon pyrolysis. FIG. 5 and the three-dimensional catalyst support were designed and studied using COMSOL Multiphysics® software.

### Example 6

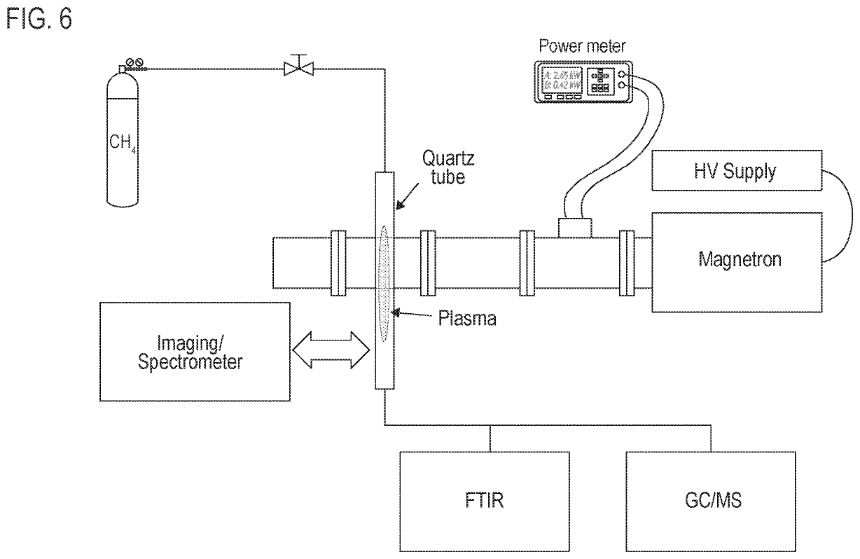

FIG. 6 depicts a schematic of a reactor/system design (experimental scale) for microwave hydrocarbon reforming.

### Example 7

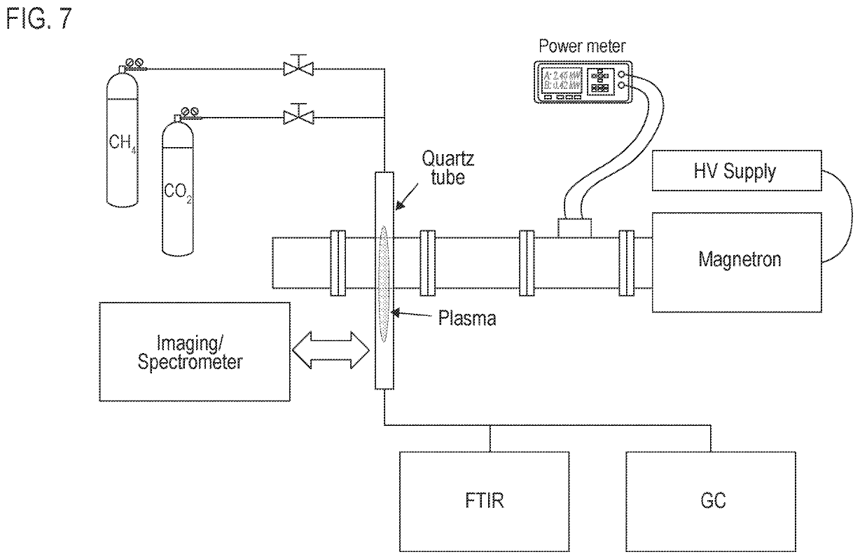

FIG. 7 depicts a schematic of a reactor/system design (experimental scale) for microwave hydrocarbon reforming.

### Example 8

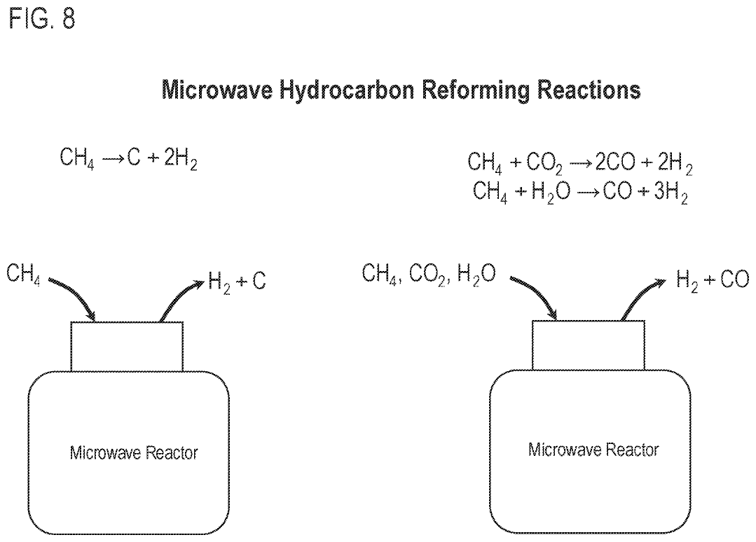

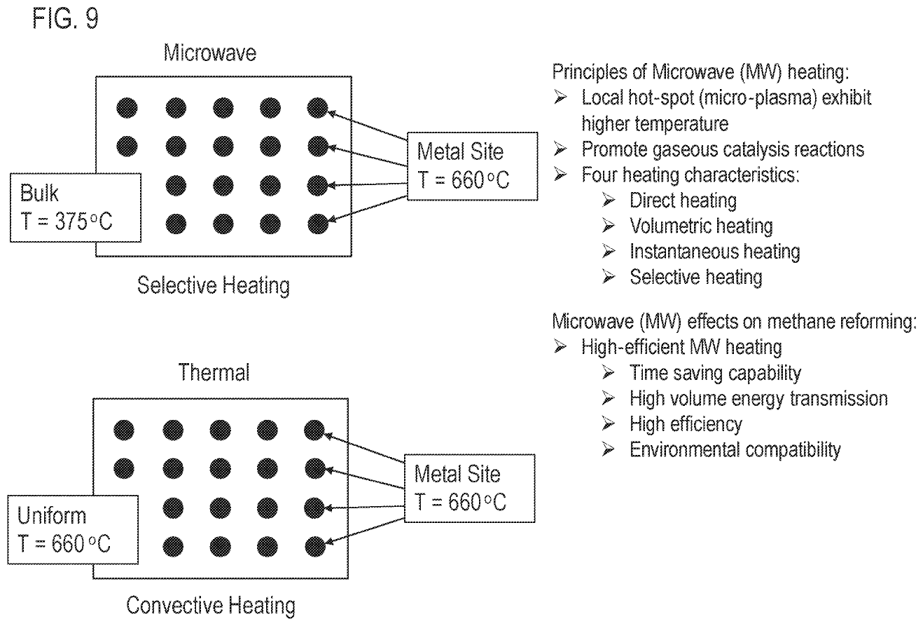

FIG. 8 depicts non-limiting examples of microwave hydrocarbon reforming reactions.

### Example 9

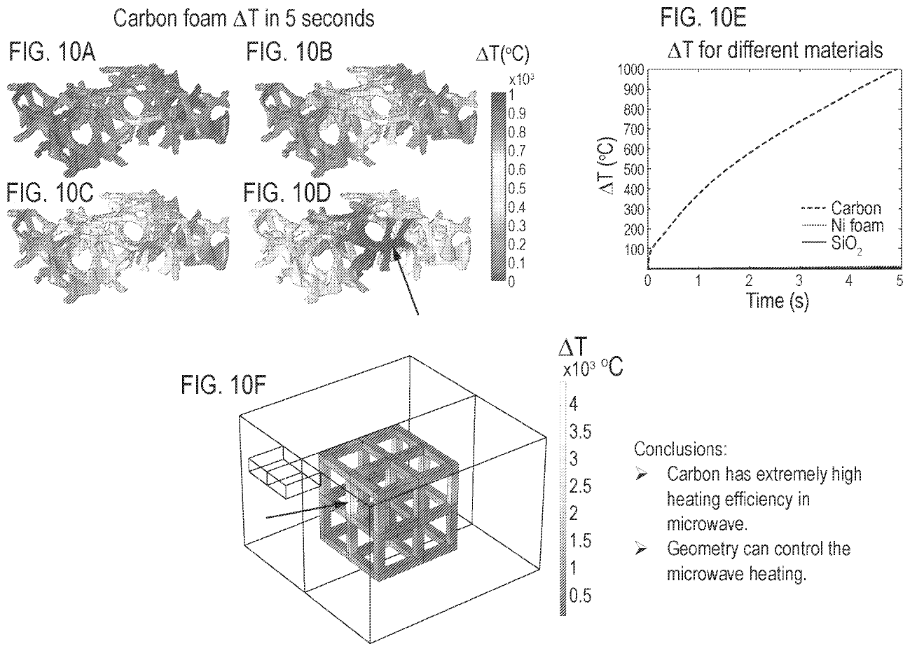

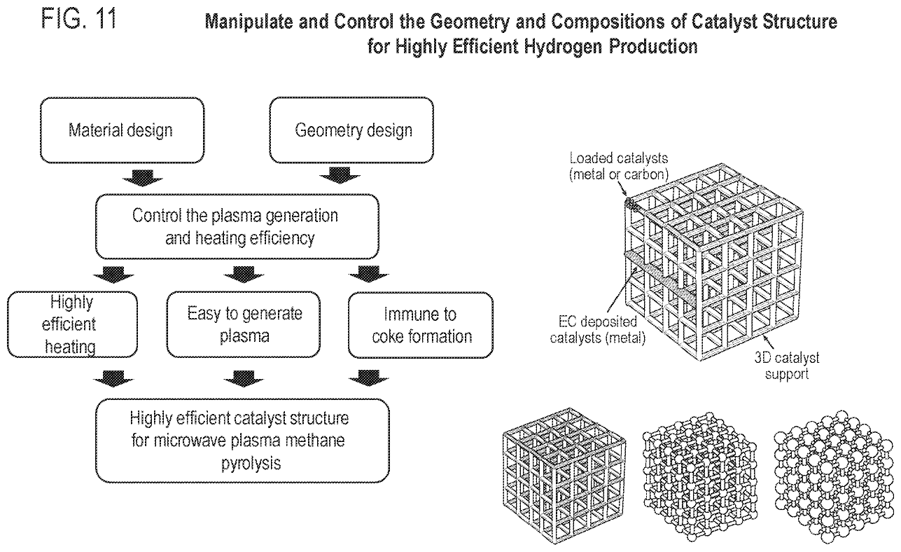

FIG. 10A-FIG. 10F depicts temperature distribution changes over time on three-dimensional carbon foam, where the heating time is 1 second (FIG. 10A), 2 seconds (FIG. 10B), 3 seconds (FIG. 10C), and 5 seconds (FIG. 10D). FIG. 10E depicts in accordance with various embodiments of the invention a temperature vs. time curve showing that the temperature quickly increases to 1000° C. in 5 seconds for the three-dimensional carbon foam structure compared to Ni foam and SiO₂. FIG. 10F depicts in accordance with various embodiments of the invention, a catalyst for microwave reforming of hydrocarbons showing the formation of a localized thermal hot spot within the three-dimensional catalyst material or on a surface of the three-dimensional catalyst material. FIG. 10A, FIG. 10B, FIG. 10C, FIG. 10D, and FIG. 10F show that the temperature distribution on the three-dimensional carbon foam is not uniform. The temperature distribution is localized to a specific area/region within the three-dimensional catalyst material or on a specific surface of the three-dimensional catalyst material thereby forming a localized thermal hot spot within the three-dimensional catalyst material or on a surface of the three-dimensional catalyst material. In FIG. 10D the position and/or area of the localized thermal hot spot (e.g., localized heating) is indicated by the arrow. In FIG. 10F the position and/or area of the localized thermal hot spot (e.g., localized heating) is indicated by the arrow. FIG. 10A-FIG. 10F and the three-dimensional carbon foam, the Ni foam, and the SiO₂ foam were designed and studied using COMSOL Multiphysics® software.

### Example 10

FIG. 12 depicts a simulated microwave reactor design used for modeling microwave reforming reactions and microwave pyrolysis reactions. The simulated microwave reactor was designed, established, and studied using COMSOL Multiphysics® software. The simulated microwave reactor was run with constants of 2.45 GHZ and 1.2 KW. The simulated electric field's oscillation direction is oriented along the Z-plane (i.e., Z-axis) throughout the entire reactor system, and the electromagnetic wave's propagation direction is oriented along the X-plane (i.e., X-axis). The dimensional details of the reactor are shown in FIG. 12. This reactor model was used to calculate heating effects on the catalyst and the surface of the quartz tube surrounding the active area (i.e., the at least one thermal hot spot). The reactor model was also used to simulate the plasma generation from the catalyst body and/or catalyst surface. Heat transfer data was calculated at constant frequency of 2.45 GHz at an initial temperature of 25° C. using the following heat transfer equations:

$$ρ {C}_{ρ} u \cdot ∇ T + ∇ \cdot q = Q + {Q}_{ted} \qquad ( Equation 1 )$$

$$q = - k ∇ T . \qquad ( Equation 2 )$$

### Example 11

FIG. 13 depicts a plot showing the changes in heating effect in a single cylindrical rod oriented lengthwise along the X-plane (i.e., X-axis) in the reactor shown in FIG. 12. The cylindrical rod had a fixed 50 μm radius and the length of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 12

FIG. 14 depicts a plot showing the changes in heating effect in a single cylindrical rod oriented lengthwise along the X-plane (i.e., X-axis) in the reactor shown in FIG. 12. The cylindrical rod had a fixed 5000 μm length and the radius of the cylindrical rod was increased along the X-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 13

FIG. 15 depicts a plot showing the changes in heating effect in a single cylindrical rod oriented lengthwise along the Z-plane (i.e., Z-axis) in the reactor shown in FIG. 12. The cylindrical rod had a fixed 50 μm radius and the length of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 14

FIG. 16 depicts a plot showing the changes in heating effect in a single cylindrical rod oriented lengthwise along the Z-plane (i.e., Z-axis) in the reactor shown in FIG. 12. The cylindrical rod had a fixed 1000 μm length and the radius of the cylindrical rod was increased along the Z-plane of the reactor. The cylindrical rod was subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 15

FIG. 17 depicts a plot showing the changes in beating effect in a single cylindrical rod oriented lengthwise along the X-plane (i.e., X-axis) in the reactor shown in FIG. 12. The plot in FIG. 17 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave beating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 16

FIG. 18 depicts a plot showing the changes in heating effect in a single cylindrical rod oriented lengthwise along the Z-plane (i.e., Z-axis) in the reactor shown in FIG. 12. The plot in FIG. 18 shows the comparison of the ratio between length and radius of the cylindrical rod independent of the individual length and radius values. Single cylindrical rods having a length of 1 mm to 5 mm, and a radius of 12.5 μm to 50 μm were modeled. The cylindrical rods were subjected to simulated microwave heating in the reactor shown in FIG. 12 for 5 seconds using COMSOL Multiphysics® software. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 17

FIG. 19 depicts simulated heating effects of two isolated cylindrical rods. In the computer simulation the first cylindrical rod is oriented lengthwise along the Z-plane (i.e., Z-axis) in the reactor shown in FIG. 12, and the second cylindrical rod is oriented lengthwise along the X-plane (i.e., X-axis) in the reactor shown in FIG. 12. The cylindrical rods were subjected to simulated microwave heating in the reactor shown in FIG. 12 for 5 seconds using COMSOL Multiphysics® software. In FIG. 19 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 18

FIG. 20 depicts the simulated heating effects of two cylindrical rods joined together at a corner junction across the Z-plane and X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 20 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 19

FIG. 21 depicts the simulated heating effects of two cylindrical rods joined together at a center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 21 the positions and/or areas of the localized thermal hot spots (e.g., localized heating) are indicated by the arrows. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 20

FIG. 22 depicts the simulated heating effects of two cylindrical rods joined together at an angled center junction across the Z-plane and the X-plane in the reactor shown in FIG. 12. In the computer simulation the first cylindrical rod is oriented lengthwise along the Z-plane (i.e., Z-axis) in the reactor in FIG. 12 and the second cylindrical rod is oriented at an angle lengthwise along the X-plane (i.e., X-axis) in the reactor in FIG. 12. The cylindrical rods were subjected to simulated microwave heating in the reactor shown in FIG. 12 for 5 seconds using COMSOL Multiphysics® software. In FIG. 22 the position and/or area of the localized thermal hot spot (e.g., localized heating) is indicated by the arrow. The simulated microwave reactor was run with constants of 2.45 GHZ and 1.2 kW. The simulated electric field's oscillation direction is oriented along the Z-plane (i.e., Z-axis) throughout the entire reactor system, and the electromagnetic wave's propagation direction is oriented along the X-plane (i.e., X-axis).

### Example 21

FIG. 23 depicts the methane pyrolysis gas chromatography results from a collection of actual methane pyrolysis experiments that were conducted using a carbon fiber catalyst in a microwave oven. The microwave oven was operated at 2.45 GHZ and 1 KW. In FIG. 23 the term “standard carbon” means 0.3 grams of carbon fiber. In FIG. 23 the term “less carbon” means 0.1 grams of carbon fiber. In FIG. 23 the term “full carbon” means 0.5 grams of carbon fiber.

### Example 22

FIG. 24 depicts the methane pyrolysis gas chromatography results from a collection of actual methane pyrolysis experiments that were conducted using a carbon fiber catalyst in a microwave oven. The experimental results shown in FIG. 24 were obtained using a “split carbon” setup. The microwave oven was operated at 2.45 GHZ and 1 kW.

### Example 23

FIG. 25 depicts the methane pyrolysis gas chromatography results from a collection of actual methane pyrolysis experiments that were conducted using a carbon fiber catalyst in a microwave oven. The experimental results shown in FIG. 25 were obtained using a “split carbon” setup. The microwave oven was operated at 2.45 GHZ and 1 kW.

### Example 24

FIG. 27A-FIG. 27H depicts time-lapse photographs of plasma generation from a single bundle of carbon fiber in a quartz tube filled with argon when subjected to microwave energy in a microwave oven. The carbon fiber used in the experiments shown in FIG. 27A-FIG. 27H possessed a long aspect ratio (i.e., a large length to radius ratio). The microwave oven was operated at 2.45 GHZ and 1 kW. FIG. 27A shows the carbon fiber bundle in the quartz tube filled with argon before being subjected to microwave energy. FIG. 27B shows the initial plasma spikes generated from a first end of the carbon fiber bundle in the presence of argon when subjected to microwave energy. FIG. 27C shows an increase in the size and position of the initial plasma spikes generated from the first end of the carbon fiber bundle in the presence of argon when subjected to microwave energy. FIG. 27D shows a further increase in the size and position of the plasma spikes generated from the first end of the carbon fiber bundle in the presence of argon when subjected to microwave energy. FIG. 27E shows a further increase in the size and position of the plasma spikes generated from the first end of the carbon fiber bundle in the presence of argon when subjected to microwave energy, and also shows plasma spikes generated from a second end of the carbon fiber bundle in the presence of argon when subjected to microwave energy. FIG. 27F shows a further increase in the size and position of the plasma spikes generated from the first end and the second end of the carbon fiber bundle in the presence of argon when subjected to microwave energy. FIG. 27G shows plasma formation at the first end and second end of the carbon fiber bundle in the presence of argon when subjected to microwave energy. FIG. 27H shows FIG. 27G shows plasma at the first end and second end of the carbon fiber bundle in the presence of argon when subjected to microwave energy.

### Example 25

FIG. 28A-FIG. 28C depicts time-lapse photographs of plasma generation from a single bundle of carbon fiber in a quartz tube filled with methane when subjected to microwave energy in a microwave oven. The microwave oven was operated at 2.45 GHZ and 1 kW. FIG. 28A shows the carbon fiber bundle in the quartz tube filled with methane before being subjected to microwave energy. FIG. 28B shows the initial plasma hot spots generated within the carbon fiber bundle or from a surface of the carbon fiber bundle in the presence of methane when subjected to microwave energy. FIG. 28C shows an increase in the quantity, size, and position of plasma hot spots (thermal hot spots) generated within the carbon fiber bundle or from the surface of the carbon fiber bundle in the presence of methane when subjected to microwave energy. FIG. 28C also shows plasma formation from within the carbon fiber bundle or from a surface of the carbon fiber bundle in the presence of methane when subjected to microwave energy.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1.-15. (canceled)

16. A catalyst for microwave reforming of hydrocarbons, comprising: a catalyst body comprising a catalyst material, wherein the catalyst body has a three-dimensional structure, and wherein the three-dimensional structure is configured to form a localized thermal hot spot within the catalyst body or on a surface of the catalyst body when subjected to microwave energy.

17. The catalyst of claim 16, wherein the three-dimensional structure comprises any geometry.

18. The catalyst of claim 16, wherein the three-dimensional structure is configured to maximize the temperature of the localized thermal hot spot.

19. The catalyst of claim 16, wherein the three-dimensional structure is configured to form a microwave plasma when subjected to microwave energy.

20. The catalyst of claim 16, wherein the catalyst body is porous.

21. The catalyst of claim 16, wherein the catalyst body comprises a carbon-based material, a metal-based material, or combination thereof.

22. The catalyst of claim 21, wherein the carbon-based material comprises at least one of carbon foam, carbon fiber, active carbon, carbon black, charcoal, coal, biomass-derived carbon, or any combination thereof.

23. The catalyst of claim 21, wherein the metal-based material comprises at least one of aluminum, stainless steel, maraging steel, nickel alloy, titanium, aluminum alloy, cobalt alloy, or titanium alloy.

24. The catalyst of claim 16, wherein the catalyst material is a carbon-based catalyst material, a metal-based catalyst material, or a combination thereof.

25. The catalyst of claim 24, wherein the carbon-based material is selected from the group consisting of carbon foam, carbon fiber, active carbon, carbon black, charcoal, coal, biomass-derived carbon, and any combination thereof.

26. The catalyst of claim 24, wherein the metal-based catalyst material comprises at least one transition metal.

27. The catalyst of claim 26, wherein the at least one transition metal is selected from the group consisting of nickel, cobalt, iron, copper, molybdenum, ruthenium, platinum, and any combination thereof.

28. A system for microwave reforming of hydrocarbons, comprising:
a reaction chamber, wherein the reaction chamber comprises at least one input port and at least one outlet port;
a catalyst of claim 16 positioned in the reaction chamber; and
a magnetron for generating microwave energy, wherein the magnetron is in communication with the reaction chamber.

29. The system of claim 28, further comprising a carbon separator in communication with the at least one outlet port.

30. The system of claim 28, further comprising a hydrogen separator, wherein the hydrogen separator is in communication with the at least one outlet port.

31. A method for microwave reforming of hydrocarbons, comprising:
providing a system for microwave reforming of hydrocarbons, wherein the system comprises a reaction chamber and a magnetron for generating microwave energy, wherein the reaction chamber comprises at least one input port and at least one outlet port, and wherein the magnetron is in communication with the reaction chamber;
positioning a catalyst of claim 16 in the reaction chamber;
contacting the catalyst with microwave energy to generate a microwave plasma in the reaction chamber;
adding a hydrocarbon feedstock to the reaction chamber via the at least one input port;
contacting the hydrocarbon feedstock with the microwave plasma in the reaction chamber; and
reforming the hydrocarbon feedstock with the microwave plasma to produce hydrogen.

32. The method of claim 31, wherein the hydrocarbon feedstock comprises natural gas.

33. A method for microwave reforming of hydrocarbons, comprising: providing a catalyst of claim 16; contacting the catalyst with microwave energy to generate a microwave plasma;
contacting a hydrocarbon feedstock with the microwave plasma; and reforming the hydrocarbon feedstock with the microwave plasma to produce hydrogen.

34. The method of claim 33, wherein the hydrocarbon feedstock comprises natural gas.

35. A use of a catalyst of claim 16 for microwave reforming at least one hydrocarbon.
